(19) United States
(12) Patent Application Publication
(10) Pub. No.: US 2015/0081258 A1
(43) Pub. Date: Mar. 19, 2015

(54) TRACKING MULTIPLE PARTICLES IN BIOLOGICAL SYSTEMS

(71) Applicant: NUMERICA CORP., Loveland, CO (US)

(72) Inventors: CHRISTOPHER P. CALDERON, DENVER, CO (US); RANDY C. PAFFENROTH, LOVELAND, CO (US)

(73) Assignee: NUMERICA CORP., Loveland, CO (US)

(21) Appl. No.: 14/030,514

(22) Filed: Sep. 18, 2013

(51) Int. Cl. G06F 17/50

(52) U.S. Cl. CPC G06F 17/5009
USPC 703/2; 703/11

(57) ABSTRACT

A method of tracking a plurality of tagged molecules in a cell in two or three dimensions may include receiving a plurality of unambiguous track segments, where each of the plurality of unambiguous track segments may include a plurality of time-valued observations of individual tagged molecules. The method may also include separating the plurality of unambiguous track segments into a plurality of time windows. The method may additionally include, for each of the plurality of unambiguous track segments, deriving one or more data sets representing features of the unambiguous track segment. The method may further include associating a first unambiguous track segment from a first time window with a second unambiguous track segment from a second time window using the one or more data sets.

### CROSS-REFERENCES TO RELATED APPLICATIONS

This application is related to co-owned U.S. patent application Ser. No. 13/597,100, filed on Aug. 28, 2012, entitled “Particle Tracking in Biological Systems” (Attorney Docket No. 94325-834076(000200US)), the entire disclosure of which is incorporated by reference into this application for all purposes.

### BACKGROUND OF THE INVENTION

The term “biomolecule” may refer to any molecule that is produced by a living organism. Biomolecules may include large macromolecules such as proteins, polysaccharides, lipids, and nucleic acids, as well as small molecules such as primary metabolites, secondary metabolites, and natural products. Living cells may contain hundreds of different biomolocules. Tracking multiple biomolocules within the complex and crowded environment associated with living cells remains a difficult problem in the field.

Modern optical microscopes are able to create high temporal and spatial resolution measurements of individual biomolecule motion in living cells by providing point spread functions in a sequence of images. The ability to track biomolecules at single-molecule resolution in their native environment permits researchers to address open questions in various fields including cell biology, nanotechnology, and virology. Accurately and reliably extracting dynamic information from these measurements may require tracking individual biomolecules for time periods ranging between a few seconds to many hours, as various physical processes of biological interest can occur over these timescales (e.g. virus capsid formation). However, it can become difficult to track invidival biomolecules for these time durations because of problems like track crossing or frequently missed detections such as those due to quantum dot blinking

### BRIEF SUMMARY OF THE INVENTION

Known techniques exist for systematically estimating “track segments” for tagged molecules. In this disclosure, “track segments” serve as input to a methods, systems, and/or products that systematically joins, or “stitches” the segments. Existing techniques have utilized discrete features to aid in this task, but the methods described herein differ in that they use continuous features derived from the track segments. Numerically fast and efficient merging of the tracks and features can be achieved in some embodiments by utilizing linear mixed effects likelihood techniques evaluated using a new matrix decomposition algorithm.

In some embodiments, a method of tracking a plurality of tagged molecules in a cell in two or three dimensions may be presented. The method may include receiving a plurality of unambiguous track segments. Each of the plurality of unambiguous track segments may include a plurality of time-valued observations of individual tagged molecules. The method may also include separating the plurality of unambiguous track segments into a plurality of time windows. The method may additionally include, for each of the plurality of unambiguous track segments, deriving one or more data sets representing features of the unambiguous track segment. The method may further include associating a first unambiguous track segment from a first time window with a second unambiguous track segment from a second time window using the one or more data sets.

In some implementations, the one or more data sets may include a data set representing a velocity of an associated tagged molecule as a function of time or spatial location. The one or more data sets may include a data set representing a matrix of effective force vectors acting on an associated tagged molecule as a function of time or spatial location. The one or more data sets may include a data set representing a diffusion coefficient for an associated tagged molecule as a function of time or spatial location. The one or more data sets may include a data set representing an effective measurement noise magnitude for an associated tagged molecule as a function of time or spatial location. Each of the plurality of tagged molecules may be tagged such that the molecule, over time, emits a gradually changing fluorescent signature. Additionally, the method may also include combining the first unambiguous track segment with the second unambiguous track segment to form a single track segment representing a path of an associated tagged molecule.

In some implementations, associating the first unambiguous track segment from the first time window with the second unambiguous track segment from the second time window using the features may include formulating an association problem using the one or more data sets representing features and solving the association problem. Associating the first unambiguous track segment from the first time window with the second unambiguous track segment from the second time window using the one or more data sets may also include creating a semi-parametric model using a Linear Mixed Effect (LME) formulation and the plurality of unambiguous track segments, computing a Maximum Likelihood Estimate (MLE) for the LME, and efficiently computing a set of Expected Best Linear Unbiased Parameters (EBLUPs) for each of the unambiguous track segments. The first unambiguous track segment from the first time window may be associated with the second unambiguous track segment from the second time window using the EBLUPs. Each of the EBLUPs may be associated with kinetic parameters that describes an interaction between the molecule and the environment inside the cell.

In some embodiments, a computer-readable memory comprising a sequence of instructions which, when executed by one or more processors, causes the one or more processors to track a plurality of tagged molecules in a cell in two or three dimensions. The instructions may cause the processor(s) to receive a plurality of unambiguous track segments. Each of the plurality of unambiguous track segments may include a plurality of time-valued observations of individual tagged molecules. The instructions may also cause the processor(s) to separate the plurality of unambiguous track segments into a plurality of time windows, and for each of the plurality of unambiguous track segments, derive one or more data sets representing features of the unambiguous track segment. The instructions may additionally cause the processor(s) to associate a first unambiguous track segment from a first time window with a second unambiguous track segment from a second time window using the one or more data sets.

In some embodiments, a system may be presented that includes one or more processors and a memory communicatively coupled with and readable by the one or more processors and comprising a sequence of instructions which, when executed by the one or more processors, cause the one or more processors to track a plurality of tagged molecules in a cell in two or three dimensions. The instructions may cause the processor(s) to receive a plurality of unambiguous track segments. Each of the plurality of unambiguous track segments may include a plurality of time-valued observations of individual tagged molecules. The instructions may also cause the processor(s) to separate the plurality of unambiguous track segments into a plurality of time windows, and for each of the plurality of unambiguous track segments, derive one or more data sets representing features of the unambiguous track segment. The instructions may additionally cause the processor(s) to associate a first unambiguous track segment from a first time window with a second unambiguous track segment from a second time window using the one or more data sets.

### BRIEF DESCRIPTION OF THE DRAWINGS

A further understanding of the nature and advantages of the present invention may be realized by reference to the remaining portions of the specification and the drawings, wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIGS. 1A-1B illustrate photographs of live cells with biomolecules that have been fluorescently tagged for tracking.

FIG. 2A illustrates a graph of trajectories for multiple particles.

FIG. 2B illustrates a graph of trajectories for multiple particles using a first type of data association algorithm, according to some embodiments.

FIG. 2C illustrates a graph of trajectories for multiple particles using a second type of data association algorithm, according to some embodiments.

FIGS. 3A-3C illustrate various candidate solutions for stitching shorter track segments together to form larger track segments, according to some embodiments.

FIG. 4 illustrates a graph of curves that were derived from the effective measurement noise associated with monitoring the z component of tagged mRNA in yeast cells.

FIG. 5A illustrates a graph of features derived from ten unambiguous track segments, according to some embodiments.

FIG. 5B illustrates a graph of ten synthetic measurement noise profiles, according to some embodiments.

FIG. 6 illustrates a sparse pattern of an example design matrix, according to some embodiments.

FIG. 7 illustrates a graph of results obtained by repeating the track stitching method multiple times, according to some embodiments.

FIG. 8A illustrates a flowchart for a method of tracking a plurality of tagged molecules in a cell in two or three dimensions, according to some embodiments.

FIG. 8B illustrates a flowchart for a method of tracking a plurality of tagged molecules in a cell in two or three dimensions, according to some embodiments.

FIGS. 9A-9B illustrate samples of an observed curve population.

FIG. 10 illustrates a block diagram illustrating components of an exemplary operating environment in which various embodiments of the present invention may be implemented, according to one embodiment.

FIG. 11 illustrates a block diagram illustrating an exemplary computer system in which embodiments of the present invention may be implemented, according to one embodiment.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Presented herein is a mathematical and computational framework for methods and systems that implement a new statistical inference process that can be used to (1) reliably process a large collection of experimental trajectories generated by single particle tracking (SPT) experiments to assist in physically interpreting measurements taken of biomolecules in a living cell; and to (2) stitch track data across time in order to extend the time duration that individual biomolecules can be observed. These methods may leverage linear mixed effects (LME) models to process features inferred from SPT data. Furthermore, some embodiments described herein may provide a new algorithm for efficiently computing the parameters defining an LME model in a numerically stable fashion. In one exemplary embodiment, the utility of a new stable and efficient LME has been demonstrated on a simulated data set.

The ability to track individual molecules in vivo with high spatial and temporal resolution in two (2D) or three spatial dimensions (3D) may offer new and exciting opportunities for quantitatively understanding the kinetics of individual biological molecules in their native environment. Quantifying the dynamics of a biomolecule within a cell is usually difficult because of the current inability to describe the constantly changing effective forces experienced by the molecule as it traverses a crowded and heterogeneous medium. As a biomolecule travels through the internal medium of a live cell, different forces within the live cell may affect the biomolecule's trajectory. Some embodiments herein can be used to infer the time changing nature of these effective forces using the observed motion of the biomolecule.

The inferred effective force vectors are examples of “features” associated with experimental data. Attaching features and other unique attributes to a biomolecule may be important because the crowded and complex cellular environment complicates unambiguously gathering single-molecule data on multiple particles for long time intervals. Measuring tracks for long time intervals is often required for accurately estimating and quantifying the effective kinetic parameters individual molecules experience in vivo. Other factors complicating the extraction of long tracks from SPT data include so-called “missed detections.” Missed detections can be induced by quantum dot blinking, photoswitchable dyes, background fluorescence, and other factors. Numerous features can be leveraged for assisting in reliably forming long tracks. For example, the 2D and 3D force vectors also generate eigenvectors and eigenvalues which can serve as additional features. Other examples of features may include diffusion coefficients and effective measurement noise).

In standard SPT experiments, biomolecules can be fluorescently tagged in vivo. This creates signals that can be dynamically tracked in 2D or 3D using microscopy tools. These microscopy tools are capable of overcoming previous resolution limitations imposed by visible light. The direct result is the dynamical measurement of individual, fluorescently tagged biomolecules—such as mRNA and proteins—in their native environment. In SPT experiments, the location of a point spread function (PSF) associated with the fluorescent emissions coming from the tagged biomolecules can be measured in order to estimate the biomolecule's position in the cell at a given time. However, at the time of this disclosure, there are many open questions associated with how to analyze and interpret the noisy sequence of time-ordered PSFs arising from these experiments. SPT experiments often yield only a sequence of image frames, each of which includes multiple similar PSFs. Embodiments provided herein provide for tracking individual PSFs between successive image frames over varying time intervals. When multiple emitters (inducing multiple PSFs) are contained in a measured image sequence, it may be difficult to unambiguously associate PSFs with molecules producing the PSFs in the time indexed image frames.

Additionally, it is currently difficult to make full use of the noisy time series of tracked PSFs in order to infer how a tagged biomolecule is interacting with other molecules in the cell. Many other biomolecules can interact with the tagged biomolecule and influence its motion, but most of these interacting particles might be untagged. The influence of untagged molecules on the tagged biomolecule can often only be quantified by effective forces and friction inferred from the PSF time series.

In order to infer models that have a biophysical interpretation, researchers must (1) determine which PSFs in multiple image frames correspond to unique biomolecules, (2) make assumptions about the effective dynamical models, and (3) develop schemes for estimating the parameters respecting the complex nature of effective thermal and measurement noise associated with the experimental data. The embodiments described herein may use effective dynamical models and schemes for estimating the parameters in order to determine which PSFs in multiple image frames correspond to unique biomolecules. In other words, some embodiments may leverage “features”, which include the output of item (3), in order to match PSFs between successive image frames.

Further complications may also be associated with the fact that the details of the numerous in vivo interactions induce substantial “heterogeneity” in the observed dynamics. No pair of trajectories is exactly alike, but researchers in biophysics and cell biology may be interested in accurately quantifying/understanding this heterogeneity. The inherent heterogeneity in features estimated from unambiguous track segments can be exploited in the track stitching methods proposed herein.

To address these and other deficiencies in the art, some embodiments discussed herein may use new LME modeling techniques to extract a set of maximum likelihood estimate (MLE) parameters describing a population of curves that summarize the dynamics of molecules in an SPT experiment. Information in the estimated best linear unbiased predictor (BLUP) can then be leveraged to stitch tracks. In some embodiments, the BLUPs can be inferred after the MLE parameters defining the LME are computed. The inputs to this procedure may include a collection of discretely sampled curves which may correspond to the estimates for the parameters respecting the complex nature of effective thermal and measurement noise (the output of item (3) mentioned above). In one implantation scenario, the estimates of parameters may be extracted using estimation techniques associated with likelihood-based time series inference methods.

### Particle Tracking Problem in the Presence of Multiple Biomolecules

Recent advances in microscopy that have enabled 2D and 3D in vivo cellular position measurements of biomolecules have led to an abundance of biologically relevant dynamical information contained in the observed biomolecules trajectories. Unfortunately, this dynamical information has not been utilized prior to this disclosure. Existing methods for analyzing a collection of trajectories all suffer from the inability to reliably track multiple particles for more than a few seconds. However, many biological processes occur over longer timescales, which may require longer time tracks. Longer time tracks may often be required to accurately estimate kinetic parameters—such as diffusion coefficients and effective forces—from experimental data. SPT embodiments discussed herein may extend the time duration that SPT data can be associated with a single biomolecule. The inferred SDE parameters can change in a statistically significant fashion over the duration of a single trajectory, presumably due to changes in sub-cellular micro-environment, thus statistical inference methods accounting for this “dynamic heterogeneity” can both quantify this effect (which may be of interest to researchers per se) and extend the amount of time that SPT data can be associated with a single biomolecule. Time indexed SDE parameters derived from unambiguous tracks can serve as “functional features” that can aid in merging tracks. Throughout, the term “track” may refer to a collection of PSFs believed to be emitted by the same biomolecule and a “functional feature” may refer to a curve derived from a collection of SDE parameters estimated from unambiguous tracks. Using these embodiments, one can utilize functional features estimated from unambiguous track segments to extend the length of a collection of tracks. For example, shorter unambiguous track segments may be “stitched together” to form longer track segments by analyzing the estimated SDE parameters. Stitching tracks together can ultimately increase the time duration that a single biomolecule can be tracked. The use of inferred functional features derived from a sequence of PSFs is vastly different than using discrete features extracted from single image statistics.

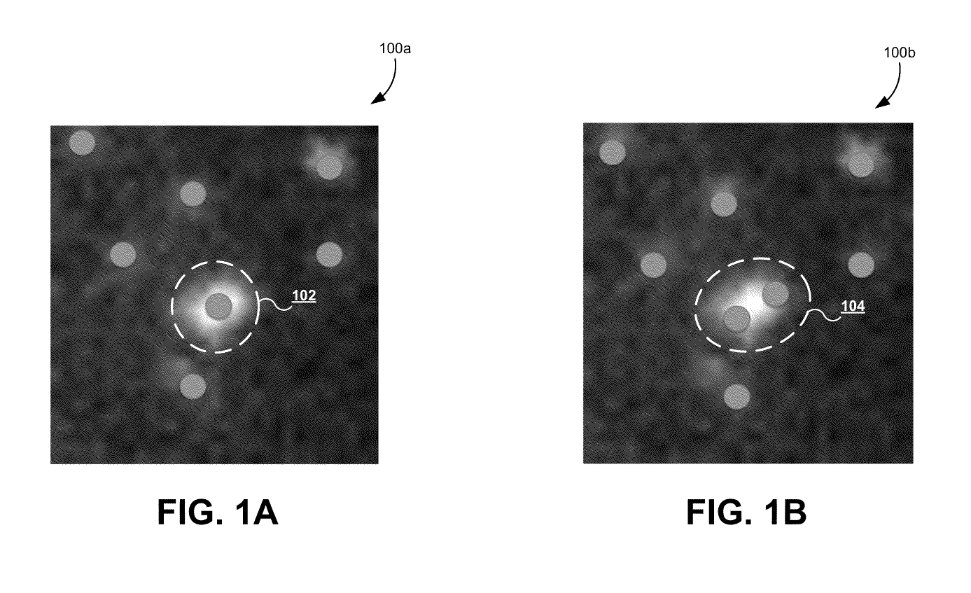

Through high resolution optical microscopy, time-ordered sequences of “light spots” can be generated. These light spots may correspond to the PSF produced by various fluorescent emitters, which may correspond to tagged biomolecules. However, keeping track of which PSF peak corresponds to each physical object had been mathematically challenging. FIG. 1A illustrates a first photograph 100a of an interior of a live cell. Inside the live cell, multiple biomolecules can be seen that have been fluorescently tagged. The tagged biomolecules form PSFs in the image, and have been identified with a dark dot in each center. FIG. 1B illustrates a second photograph 100b of the interior of the live cell. The second photograph 100b may represent an image of the same area of the live cell as the first photograph 100a at the same time point, but with a different number of fitted candidate PSFs. Area 102 of the first photograph 100a shows one candidate PSF. Area 104 of the second photograph 100b may correspond to the same physical location as area 102. However, area 104 now indicates two candidate PSFs that have been identified in the same area. These figures illustrate the difficulty of tracking individual PSFs in a crowded live cell environment in a single cell. The embodiments described herein can connect candidate PSFs in two or more images. Solving the association problem needs to account for imperfect PSF fitting in one or more frames, resulting in spurious PSFs and/or missed detections (e.g., induced by proposing the wrong number of PSFs in a frame).

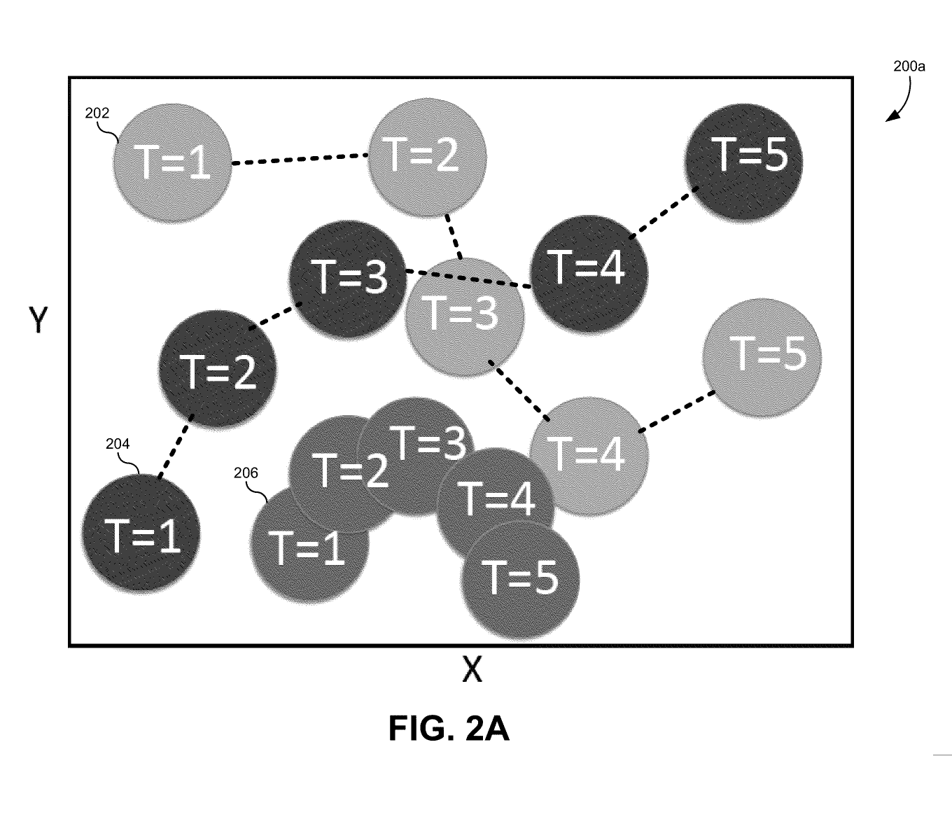

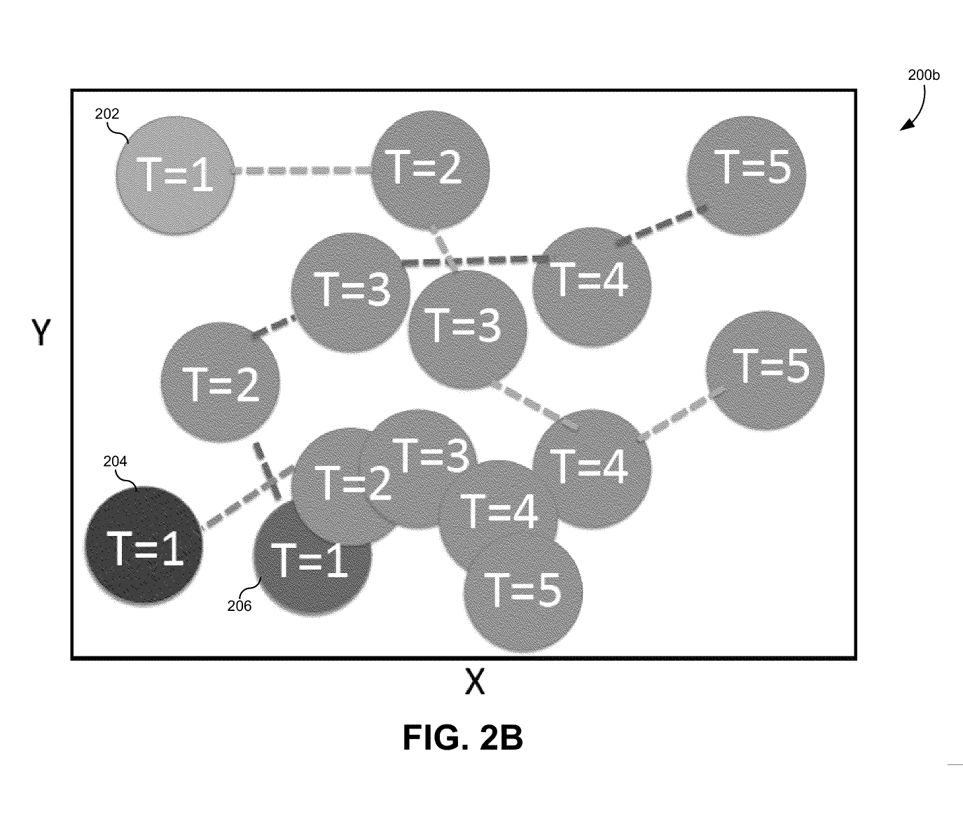

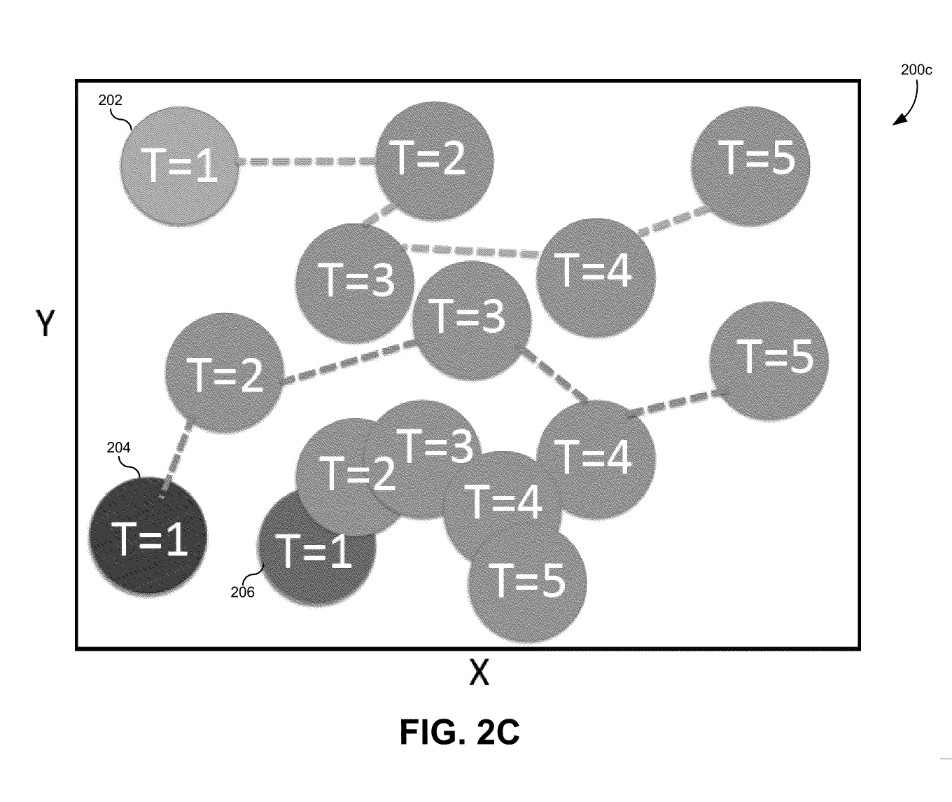

The association problem is further illustrated in FIGS. 2A-2C. FIG. 2A illustrates a graph 200a of trajectories for three different particles. Each trajectory is comprised of five locations, each captured at a different instant in time. For example, trajectory 202, trajectory 204, and trajectory 206 each include a particle location labeled “T=1”. Similarly, each trajectory includes a particle location labeled “T=2”, and so forth. Generally, particle locations captured at the same time instant are labeled with the same “T=i” label. Graph 200a may represent the “truth” of the locations and identities of the three particle trajectories 202, 204, 206.

However, the data in real experiments does not conveniently come with such a labeling scheme; researchers only have a collection of unlabeled PSF peaks collected at different discrete times. At any given initial time, one can assign arbitrary labels to a collection of observed PSF peaks, but determining which future PSF peaks correspond to the labeling scheme used at the initial time is the essence of the data association problem.

Data association algorithms may attempt to form tracks, or consecutive particle locations forming a trajectory, by using similarity measures to systematically make these decisions. For example, FIG. 2B illustrates a graph 200b of trajectories for the three different particles using a first type of data association algorithm. Similarly, FIG. 2C illustrates a graph 200c of trajectories for the three different particles using a second type of data association algorithm. Graphs 200a, 200b, and 200c illustrate that many different tracks may be computed from the same set of particle images.

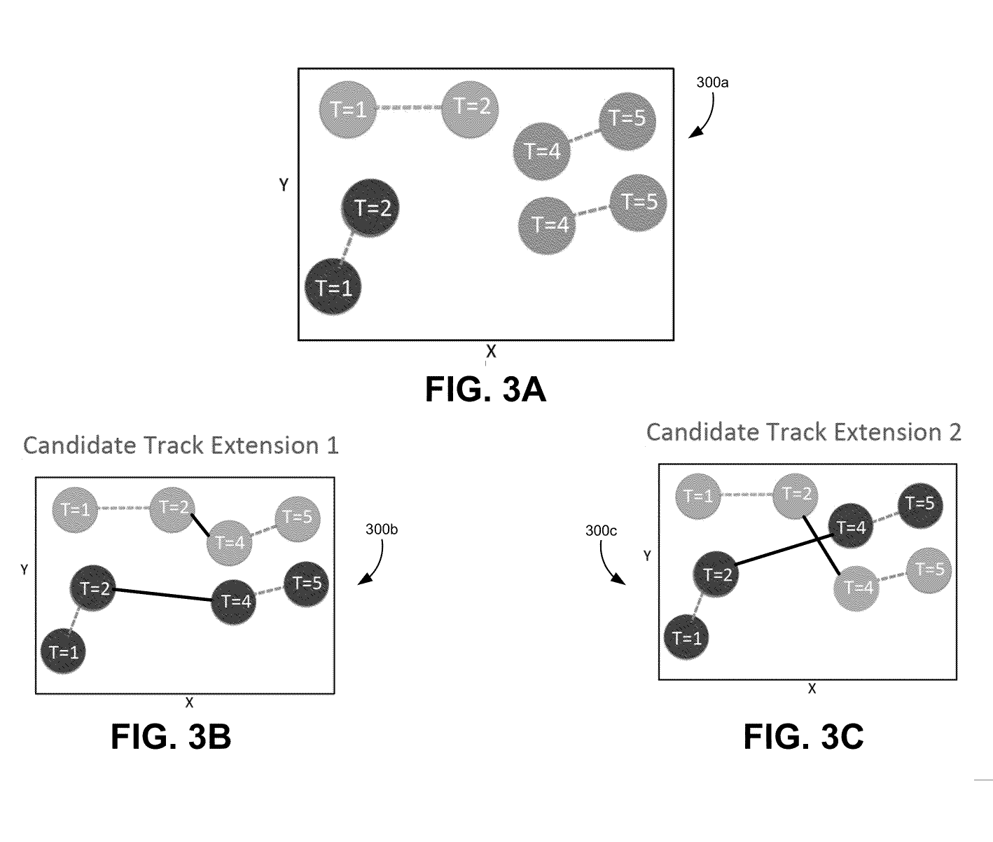

Despite the ambiguity that plagues current methods for forming complete particle tracks, these data association algorithms can often be useful in forming short segments of tracks where the association can be determined to be unambiguous through formal routines, such as those found in Kragel, B, Herman, S, Roseveare, N (2012), IEEE Transactions on Aerospace and Electronic Systems 48:1870-1888. Some embodiments herein can be used to “stitch” two or more of these unambiguous short track segments together to form an elongated track. FIG. 3A illustrates a graph 300a of short track segments, each segment joining two PSFs. The PSFs at “T=3” in FIG. 2A can be presumed missing, due to phenomena like quantum dot blinking or track crossing that commonly complicate robust PSF track estimation. The approach discussed herein provides a computational approach for systematically joining track segments to extend previously existing tracks. The methods described herein do not require assuming that the number of biomolecules actively emitting PSFs is constant. For example, FIG. 3B and FIG. 3C illustrate graphs 300b, 300c, of candidate stitching solutions that stitch together the shorter track segments of FIG. 3A to form longer track segments.

In the following sections, a general overview of a track stitching method will be presented. The mathematical details of the data processing steps are then each described individually. First, an input may be provided that is made up of discretely sampled or derived feature data derived from unambiguous track segments. Second, each track and the corresponding feature data may be may be separated into frames. Third, semi-parametric models may be prepared. Fourth, the “Expected Best Linear Unbiased Parameters” (EBLUPs) may be inferred. Fifth, the normalized EBLUPs may be associated in disjoint frames of data. The output of this method may include a new set of time extended tracks.

1—Discretely Sampled Feature Data Derived from Unambiguous Track Segments

Some embodiments may begin by processing a plurality of unambiguous track segments in order to derive feature data. Unambiguous tracks may include multiple time ordered measurements that can be reliably assigned to one biomolecule. The measurement data making up a track can be used to estimate parameters summarizing the force vectors the biomolecule experiences in the live cell. Additionally, quantities like the effective measurement noise and diffusion coefficient characterizing a portion of the track can be computed. Merely by way of example, one method of estimating parameters in a single particle trajectory is outlined in co-owned U.S. patent application Ser. No. 13/597,100, filed on Aug. 28, 2012, entitled “Particle Tracking in Biological Systems” (Attorney Docket No. 94325-834076(000200US)), which is incorporated herein by reference for all purposes as stated above.

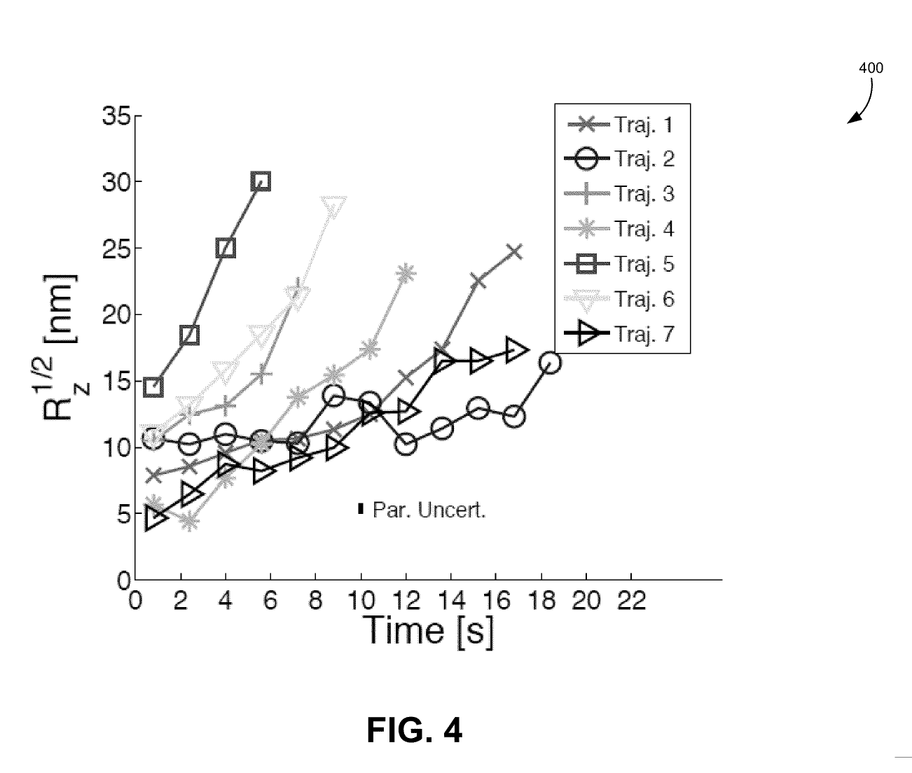

In one implementation, feature data from unambiguous track segments was derived for this operation. FIG. 4 illustrates a graph 400 that includes batch of curves that were derived from the effective measurement noise associated with monitoring the z component of tagged mRNA in yeast cells. Although the basic curve features systematically vary between different trajectories, there is still a high degree of smoothness in the estimated effective measurement noise vs. time. Furthermore, there is a common population curve that the individual trajectories share. The non-trivial trend in “subject-specific” effective measurement noise curves may be due in part to trajectory specific background fluorescence, differing numbers of active emitters, and other phenomena known to complicate photon counting. The measurement noise is difficult to compute from a priori considerations, but the effective measurement noise can be inferred from candidate track segments. The smooth evolution of these functional features can be used to stitch tracks together.

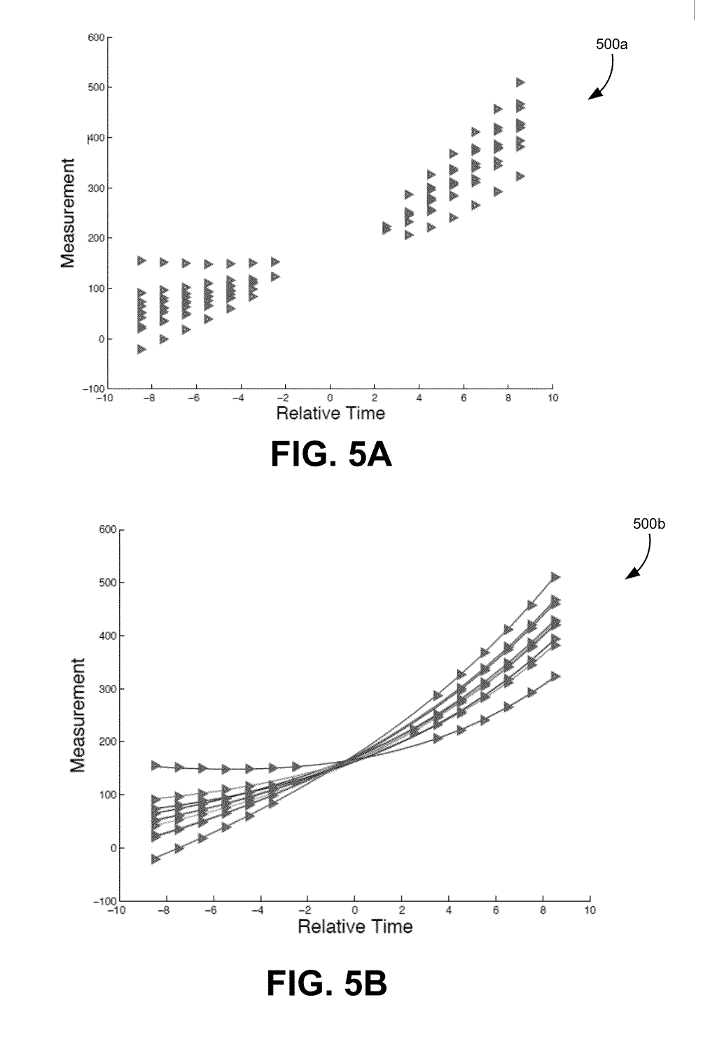

In a controlled example using data generated via simulation, FIG. 5A illustrates a graph 500a of features derived from two sets of ten unambiguous track segments. FIG. 5B illustrates a graph 500b of ten synthetic measurement noise profiles. The curves in graph 500b represent the “true” trajectories for the particles corresponding to the features of graph 500a. It should be noted that these feature observations are derived from tracks that are discreet in nature, and as such they are usually not easily connected as they are in graph 500b. The synthetic example of FIGS. 5A-5B will be subsequently used to illustrate the remaining operations of the track stitching process.

### 2—Framing the Track and Feature Data

Next, the discrete features from track segments may be separated into two or more frames. As used herein, the term “frame” may be used to convey a window of time where the track identity of two or more biomolecules is unambiguous. For example, FIG. 5A illustrates discretely sampled function features for ten tracks different. In graph 500a, there are two frames of data. The first frame, or left frame, includes points associated with a relative time value of less than zero. The second frame, or right frame, includes points associated with a relative time value of greater than zero. In this example, the missed detections at time zero may be induced by some event, such as a simulated background fluorescence flash, that complicates PSF estimation. In each panel, an unambiguous track ID can be assigned to each discretely observed feature. The examples that follow focus on the 2D association problems, as the number of frames determines the dimensionality of the association problem, but multiple frame problems can also be considered using multiple hypothesis tracking (MHT) approaches.

### 3—Setting Up a Semi-Parametric Model Using a Linear Mixed Effect (LME) Formulation

Generally, any type of semi-parametric regression may be used in this operation. In one embodiment, a type of semi-parametric regression considered is outlined in Ruppert, Wand, and Carroll, Semi-parametric Regression, Cambridge University Press, 2003, Chapter 9. Semi-parametric regression may be leveraged to estimate parameters defining subject-specific curves. For example, the common “population curve” can be estimated with nonparametric methods while the subject-specific curves can be estimated parametrically.

An unobservable population curve, denoted by f(•), can be estimated using regression splines. Equations (1)-(2) provide an illustrative example, where t_{L} denotes track number “to the left” of relative time zero, t_{R} denotes tracks “to the right” of relative time zero, y corresponds to the inferred measurement noise at observation xᵢ, x corresponds to time, and ∈ᵢ represents measurement noise associated with estimating y at xᵢ. Note that track numbers are denoted by the superscripts. The subject-specific parameters (a^{(t}^{_{L}}⁾, b^{(t}^{_{L}}⁾, a^{(t}^{_{L}}⁾), b^{(t}^{_{L}}⁾) can be simultaneously measured by assuming a normal distribution for the slope (b) parameters and a normal distribution for the intercept (a) parameters.

yᵢ^{(t}^{_{L}}⁾=a^{(t}^{_{L}}⁾+b^{(t}^{_{L}}⁾xᵢ^{(t}^{_{L}}⁾+f(xᵢ^{(t}^{_{L}}⁾)+∈ᵢ^{(t}^{_{L}}⁾;

t_{L}=1, . . . ,N_{tracks};i=1, . . . Nₜ_{_{L}} (1)

yᵢ^{(t}^{_{R}}⁾=a^{(t}^{_{R}}⁾+b^{(t}^{_{R}}⁾xᵢ^{(t}^{_{R}}⁾+f(xᵢ^{(t}^{_{R}}⁾)+∈ᵢ^{(t}^{_{R}}⁾;

t_{R}=1, . . . ,N_{tracks};i=1, . . . Nₜ_{_{R}} (2)

The problem stated in equations (1)-(2) above can be posed as a linear mixed effect model where a low-order polynomial is used for the fixed effects for the population curve, and a generic Truncated Power Function (TPF) or B-spline basis can be used for the population curve random effects. In the above model, where it is assumed that the subject specific curves are parameterized by a slope and intercept coming from a mean zero normal distribution with a priori unknown covariance, the model of y:=(y^{(t}^{_{L}}^{)T}, y^{(t}^{_{R}}^{)T})^{T} can be written as:

$$y = ( \begin{matrix}X \\ ⋮ \\ X\end{matrix} ) β + ( \begin{matrix}{Z}^{( 1 )} ( θ ) & & 0 \\ & ⋱ & \\ 0 & & {Z}^{( N )} ( θ )\end{matrix} ) {b}^{( T )} + ( \begin{matrix}Z ( θ ) \\ ⋮ \\ Z ( θ )\end{matrix} ) b + ɛ . \qquad ( 3 )$$

In equation (3), the vector b^{(T)} denotes the collection of subject-specific parameters, here (a, b), associated with each track in each frame. A well-known relationship between least squares optimization problems and the MLE of an LME of a model appealing to normally distributed random effects can be used to show that the likelihood of the LME can be computed by the following equations.

$$\begin{matrix}{Z}_{θ} := ( \begin{matrix}{Z}^{( 1 )} ( θ ) & & 0 & Z ( θ ) \\ & ⋱ & & ⋮ \\ 0 & & {Z}^{( N )} ( θ ) & Z ( θ )\end{matrix} ) & ( 4 ) \\ u := ( \begin{matrix}{b}^{( T )} \\ b\end{matrix} ) & ( 5 ) \\ {L}_{θ} {L}_{θ}^{T} := {Z}_{θ}^{T} {Z}_{θ} + I ; {L}_{θ} {L}_{θ}^{T} \tilde{u} := {Z}_{θ}^{T} ( y - X β ) ; \\ {r}_{θ , β}^{2} := {min}_{u} ( {‖ y - X β - {Z}_{θ} u ‖}_{2}^{2} + {‖ u ‖}_{2}^{2} ) & ( 6 ) \\ {r}^{2} ( θ , β , X , {Z}_{θ} , \tilde{u} , u ) := {r}_{θ , β}^{2} + {‖ {L}_{θ}^{T} ( u - \tilde{u} ) ‖}_{2}^{2} & ( 7 ) \\ \begin{matrix}ℒ ( θ , β , σ ) = {\int }_{{ℝ}^{q}} \frac{1}{{( 2 π {σ}^{2} )}^{( n + q ) / 2}} exp ( - \frac{{r}^{2} ( θ , β , X , {Z}_{θ} , \tilde{u} , u )}{2 {σ}^{2}} ) d u \\ = \frac{exp ( - \frac{{r}_{θ , β}^{2}}{2 {σ}^{2}} )}{{( 2 {πσ}^{2} )}^{n / 2} \vert {L}_{θ} \vert}\end{matrix} & ( 8 )\end{matrix}$$

Equation (8) above illustrates how to obtain the likelihood function by integrating out the random effects that are assumed to come from a standard normal. This approach would be understood by one having skill in the art in light of the rest of this disclosure. Note that n represents the number of observations, and q represents the number of random effects.

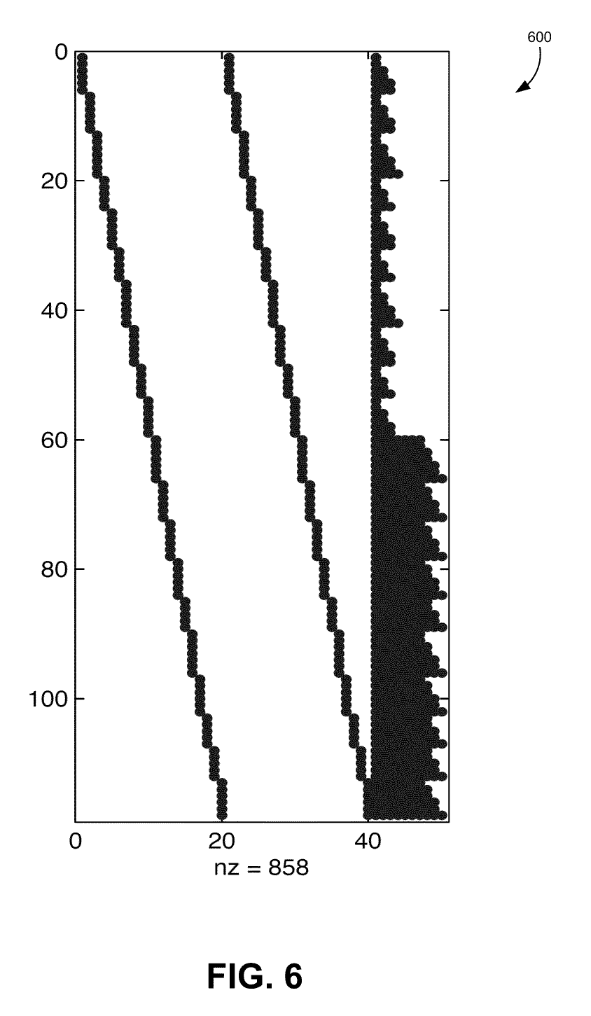

However, the condition number of the Z_{θ} matrix can cause numerical problems. In the problem considered here, the Z_{θ} is sparse and our formulation of the problem results in a specific type of sparsity pattern. FIG. 6 illustrates a sparse pattern of an example Z_{θ} matrix 600. The dark sections of Z_{θ} matrix 600 illustrate the row/column entries that are assigned nonzero values.

The process presented in the next section is equipped to handle the general case regardless of the condition number on Z_{θ} (the matrix can be mathematically singular). This is one of the unique characteristics of the approach used by some of the embodiments discussed herein. Existing LME solvers appeal to Cholesky factorizations that can encounter numerical problems when solving the penalized least squares problems shown above. These will also be discussed in more detail later in this disclosure.

4—Extracting MLE Parameters of the LME with a Numerically Stable Process

Finding the MLE of equation (8) in the case of normally distributed random effects can be solved by using penalized least squares regression. Since the procedure contains several algorithmic steps and sub-steps that require various mathematical definitions, the details are deferred to the final subsection of this disclosure. That section provides the mathematical details for both the general case (arbitrary covariance matrix on random effects) and the “canonical” form (random effects proportional to a scalar times the identity matrix) of an LME with mean zero. Normally distributed random effects can be efficiently solved with the method proposed herein.

### 5—Inferring the Expected Best Linear Unbiased Parameters (EBLUPs)

Once the MLE parameters defining the LME model are computed, the EBLUP of the unobservable random effects vectors can be inferred. As shown in Ruppert, Wand, and Carroll, Semi-parametric Regression, Cambridge University Press, 2003, one can define the EBLUPs as the solution to the following optimization problem:

(\hat{β}_{α},û_{α})≡arg min_{(β,u)}∥y−(Xβ+Zu)∥₂²+α∥D^{P}u∥₂² (9)

The MLE estimate defines the regularization parameter (a). The left-hand-side of equation (9) may be readily obtained from the output from the previous step and described in greater detail below.

### 6—Associating Normalized EBLUPs in Disjoint Frames of Data

At this stage, the EBLUPs corresponding to the tracks in each frame can be associated/paired with either a unique track in another frame or a “null node”. The “null node” case suggests that a biomolecule in one frame is not present in the other frames under consideration. The random effects parameters (for parameter identification purposes) are assumed to come from a mean zero population. In some embodiments, in each frame, the EBLUPs defining the subject specific curve parameters can be adjusted to have an empirical mean of zero. Additionally, the estimated matrix square-root of the MLE covariance structure can be used to standardize the mean-adjusted, subject-specific curve parameters. The distance between the standardized subject specific curves can be used to formulate a cost matrix where, for example, the distance between the normalized parameters defining the subject specific parameters define the arc costs. Standard association algorithms, such as the Jonker-Volgenant-Castanon (JVC) algorithm, can then be used to associate the estimated subject specific curve parameter vectors in each frame.

### 7—Generating a New Set of Time-Extended Tracks

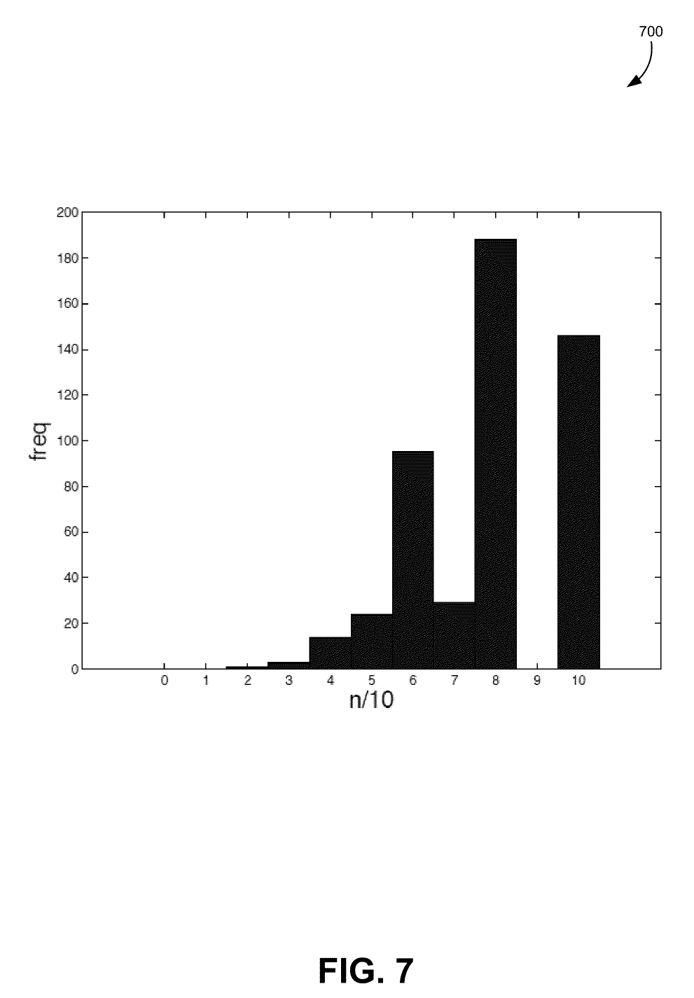

Finally, the underlying measurements in the track segments connected by the above association problem can be merged to form an extended track in cases where a track segment in one frame is successfully associated with another track segment in a different frame. Using the example illustrated by FIG. 5B, between eight and ten associations were correctly made. FIG. 7 illustrates a graph 700 of results obtained by repeatedly applying the track stitching method over multiple realizations. In this particular example, the procedure was repeated 100 times. Graph 700 in FIG. 7 displays the variation in accuracy obtained when attempting to connect ten track segments in one frame to ten track segments in another frame with different realizations. All realizations followed a single LME data-generating process whose parameters were not revealed to the algorithm processing the data in this example.

### Example Method for Particle Tracking

In the previous sections, various embodiments of methods for tracking a molecule in a living cell have been discussed in great detail. This section outlines a general heuristic that may be used to track a particle, according to one exemplary embodiment. It will be understood that many of the details discussed in the previous section are not discussed specifically in this method for brevity. However, any and/or all of the details, models, methods, parameter, or equations can be used where appropriate in this method.

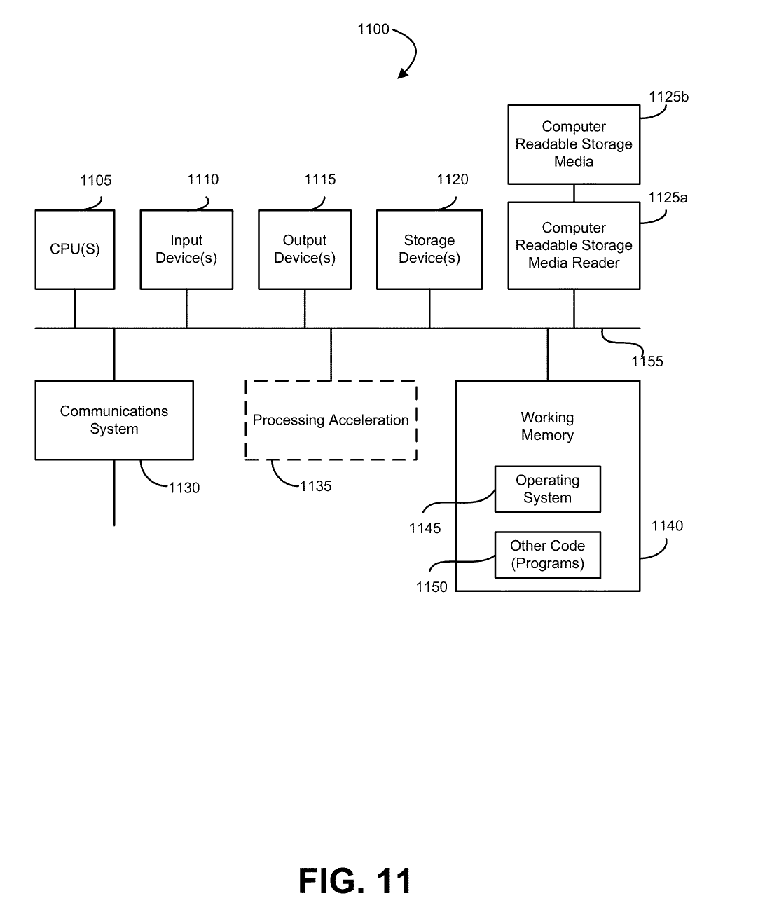

Each of the methods discussed below may be implemented in a computer system, such as computer system 1100 of FIG. 11 (discussed further below). Additionally, the methods may be implemented by one or more processors that are configured to execute the steps of the method. The method steps may be stored in a memory communicatively coupled to and readable by the one or more processors, and may be embodied by a set of instructions. Such a set of instructions may be stored on a computer-readable medium. In one embodiment, a computer-readable medium may include a non-transient and/or tangible computer-readable medium.

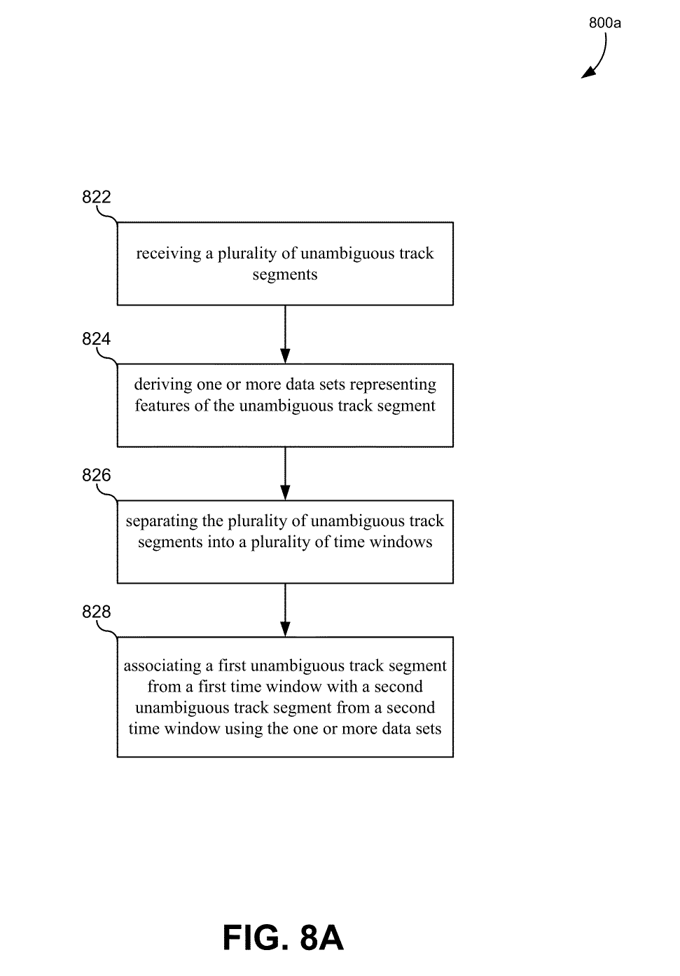

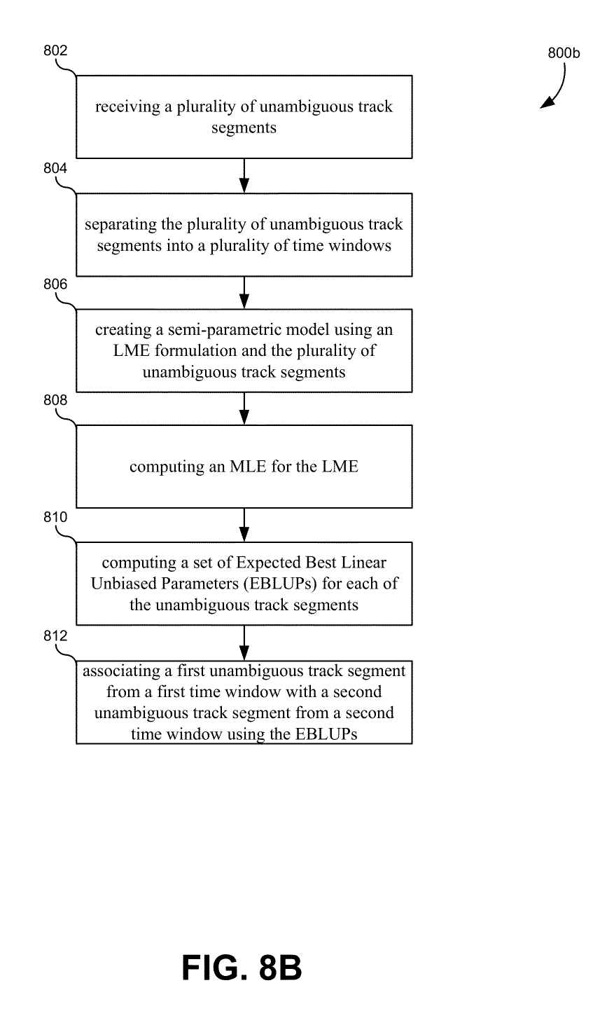

FIG. 8A illustrates a flowchart 800a for a method of tracking a plurality of tagged molecules in a cell in two or three dimensions, according to some embodiments. It should be noted that the steps in flowchart 800a generally follow the steps described above in this disclosure. Any of the steps in flowchart 800a may be augmented, altered, or otherwise implemented in various embodiments according to the descriptions given throughout. Therefore, flowchart 800 is not meant to be limiting, but rather is meant to provide a general algorithmic structure for performing at least one version of this method.

The method may include receiving a plurality of unambiguous track segments (822). The unambiguous track segments may each include a plurality of time-valued observations of molecules within a cell. For example, a particular one of the plurality of tagged molecules may form at least one of the unambiguous track segments. The particular one of the plurality of tagged molecules may also correspond to multiple unambiguous track segments. In some cases, each of the plurality of tagged molecules may be tagged such that the molecule emits a gradually changing fluorescent signature.

The method may additionally include deriving one or more data sets representing features of the unambiguous track segments (824). The data sets representing features can be distinguished from the data representing the unambiguous track segments. The data representing the unambiguous track segments may include a series of time-stamped location markers. For example, this may include coordinates of the beginning and/or ending of a tagged molecule of the unambiguous track. In contrast, the data sets representing features may be derived from the unambiguous track segments themselves. For example, the series of time-stamped location markers may be used to derive a second set of data representing a feature of the associated tagged molecule.

In various embodiments, the features may be representative of kinetic parameters associated with the tagged molecule. The features may represent values associated with interactions between the molecule and an environment inside the living cell. The features may also represent physical characteristics of the tagged molecule. In some embodiments, the one or more data sets representing features may include a data set representing a velocity of an associated tagged molecule as a function of time or spatial location. A data set may also represent an effective force acting on an associated tagged molecule as a function of time or spatial location. A data set may also represent a diffusion coefficient for an associated tagged molecule as a function of time or spatial location. A data set may also represent a measurement noise for an associated tagged molecule as a function of time or spatial location. A data set may also represent a brightness, fluorescence, intensity, color, and/or other visual characteristic of the tagged molecule. Note that these are merely exemplary features listed above, and not meant to be limiting. Some embodiments may include other features that can be derived from the unambiguous track data.

The method may also include separating the plurality of unambiguous track segments into a plurality of time windows (826). The tracks assigned to a particular time window may each be associated with different tagged molecules, and may include measurements collected at nearly the same time.

The method may further include associating a first unambiguous track segment from a first time window with a second unambiguous track segment from a second time window using the features (828). In other words, this step may include stitching together to track segments that are believed to belong to the same tagged molecule. The determination may be made using the one or more data sets representing the features. For example, a fluorescent decay curve associated with the first track segment may be matched with a fluorescent decay curve of the second track segment. In another example, a diffusion coefficient may be matched between the first and second track segments. In some embodiments, the first and second track segments may be sequential, while in other embodiments, the first and track segments may be separated in time by other track segments, or by windows where no unambiguous track segments exist. In some embodiments, the one or more data sets may be used in combination with the raw track data to stitch track segments together.

It will be understood that the use of a first and second track segment is merely exemplary and highlights a single stitching operation. In many embodiments, many track segments associated with many tagged molecules may be analyzed together using the same process. Associating track segments together using the derived features may be carried out for many unambiguous track segments, and may result in longer stitched-together track segments associated with many tagged particles.

There are a number of different ways to associate track segments together using the derived features. In some embodiments, associating track segments may be accomplished by formulating an association problem using the one or more data sets represent features, and then solving the association problem to yield a set of probabilities indicating which track segments belong to the same tagged molecule. In one particular embodiment, the association problem may include a semi-parametric model using an LME formulation as described elsewhere in this disclosure.

FIG. 8B illustrates a flowchart 800b for a method of tracking a plurality of tagged molecules in a cell in two or three dimensions, according to some embodiments. It should be noted that the steps in flowchart 800 may include some specific details related to a particular type of association problem from flowchart 800a. Therefore, flowchart 800b may include all of the features described in relation to flowchart 800a, as well as any other embodiments described throughout this disclosure. Therefore, flowchart 800b is not meant to be limiting, but rather is meant to provide a specific algorithmic structure for performing at least one version of this method for exemplary purposes only.

As with flowchart 800a, the method may include receiving a plurality of unambiguous track segments (802), and separating the plurality of unambiguous track segments into a plurality of time windows (804). The method may also include creating a semi-parametric model using an LME formulation and the plurality of unambiguous track segments (806). It will be understood that the LME approach is merely exemplary and not meant to be limiting. For example, any nonlinear mixed effects modeling approach could also be used. The method may additionally include computing an MLE for the LME (808), and computing a set of EBLUPs for each of the unambiguous track segments (810). In some embodiments, each of the EBLUPs may be associated with kinetic parameters that describe an interaction between the molecule and the environment inside the cell.

Using the EBLUPS, the method may further include associating unambiguous track segments together to form elongated track segments (812). For example, a first track segment from a first time window may be associated with a second unambiguous track segment from a second time window. These two track segments may be joined or combined to form a single track segment. Furthermore, additional steps may be added or removed depending on the particular embodiments. One of ordinary skill in the art would recognize many variations, modifications, and alternatives.

### Detailed Description of Extracting MLE Parameters of the LME

One of the steps in the track stitching method described above involved finding the MLE of equation (8) in the case of normally distributed random effects can be solved by using penalized least squares regression. This procedure contains several algorithmic steps and sub-steps that require various mathematical definitions, the details are described in detail in this subsection. This section provides the mathematical details for both the general case (arbitrary covariance matrix on random effects) and the “canonical” form (random effects proportional to a scalar times the identity matrix) of an LME with mean zero. Normally distributed random effects can be efficiently solved with the method described below.

Finding the MLE may utilize a novel, numerically stable and efficient for constructing penalized spline (P-spline) models that can minimize a quadratic penalty without making unnecessary numerical approximations. Several P-spline applications require the numerical solution of many least squares problems; let these different solutions be indexed by a, i.e. equation (9) repeated here for convenience:

\hat{β}_{α}^{α}:=(\hat{β}_{α},û_{α})≡arg min_{(β,u)∥}y−(Xβ+Zu)∥₂²+α∥D^{P}u∥₂² (9)

where y may be a vector containing noisy function samples, a may be a given smoothing parameter, D^{P} may be a penalty matrix, X may be a power basis matrix, and Z may be the spline matrix. Occasionally parameters influenced by a may contain a in the subscript to emphasize dependence. The superscript “a” denotes the column vector formed by concatenating the fixed and random effects vectors. Also note that all concatenations of vectors denote column vectors, and the vector transpose symbols are omitted when the context is clear as above. Many different a values have been proposed in an attempt to find the “best” smoothing parameter, \hat{α}, using some criterion. P-splines are useful in part because they can parsimoniously represent curves using ideas coming from low-rank regression splines, and because they can be formulated in terms of linear mixed models. The latter feature facilitates the formulation of more complex semi-parametric models. However, existing algorithms can encounter problems either with efficiency and/or numerical stability when the condition number of Z is large.

The method used by some embodiments can reliably compute various quantities associated with a given α>0 if the proposed Z is ill-conditioned or even exactly rank-deficient. The numerical stability is attractive in situations where the user has little or no control over the design matrices X and Z used in the P-spline problem. The algorithm was motivated by the need to accurately and efficiently compute with ill-conditioned Z associated with a particular class of P-spline problems using the truncated power function (TPF) basis. When the algorithm is tailored to the TPF basis, it can be demonstrated to be extremely efficient because solutions to the collection of least squares problems can be computed in a vectorized fashion for a large grid of α's. In addition, a variety of other statistical quantities such as the residual sum of squares and the generalized cross validation (GCV) can also be computed in a vectorized fashion. The algorithm also shows promise in complex linear models where nonlinear subject specific curves need to be estimated. Possible high throughput applications may include analyzing mass spectrometry signals containing low frequency baseline contamination and longitudinal modeling.

The method may exploit the linear model structure and partition the spline coefficient vector into P (“penalized”) and F (“free”) columns. A feature of the algorithm is its ability to exploit this partitioning to gain computational efficiency when solutions associated with several a and/or D are required. A superscript F and P is used on both vectors and matrices, e.g. u=[u^{F}, u^{P}]^{T} or Z=[Z^{F}, Z^{P}]. The total number of columns corresponding to the P entries is denoted by n^{P}. In standard P-spline applications n^{P}=K, but examples where n^{P}>K are also considered herein. The power basis vector of coefficients are not penalized in this formulation. However this case can readily be accounted for by relabeling the vector of power basis and spline basis coefficients. Note that the partitioning reveals that the penalty term (β^{α})^{T}D^{T}Dβ^{α} appearing above is equivalent to (u^{P})^{T}(D^{P})^{T}D^{P}u^{P}.

The algorithm performs a series of matrix operations that may result in outputs that can be used to solve the quadratic programming problem in augmented form using structured QR factorizations. The QR factors facilitate the finding of the \hat{β}_{α}^{α} that minimizes

$${‖ ( \begin{matrix}C \\ \sqrt{α} D\end{matrix} ) {β}_{α}^{a} - ( \begin{matrix}y \\ 0\end{matrix} ) ‖}_{2}^{2} . \qquad ( 10 )$$

This is the proper numerical formulation. However, prior to this disclosure, there did not exist efficient and stable P-spline methods for computing this solution for multiple candidate a or D's that do not introduce arbitrary cut-off criteria. The numerical solution in the disclosure need only compute the expensive QR factorization of C once, without pivoting. After this, the algorithm can operates on matrices containing O(np) rows and columns. This fact directs focus onto D^{P} as opposed to D. The matrix factorization used facilitates processing multiple candidate α and D^{P}'s.

The computational method used by some embodiments described herein may be performed by processor, and may include the following steps:

### Matrix Factorization Steps:

(a) Obtain the QR decomposition of C=QR.
(b) Partition result above as

$$QR = ( {Q}^{F} , {Q}^{P} ) ( \begin{matrix}{R}_{11}^{F} & {R}_{12} \\ 0 & {R}_{22}^{P}\end{matrix} )$$

### (c) Obtain the SVD of R₂₂^{P}=USV^{T}.

(d) Form the following matrices:

$$\begin{matrix}\tilde{Q} = ( {Q}^{F} , {Q}^{P} U ) , \tilde{V} = ( \begin{matrix}I & 0 \\ 0 & {V}^{T}\end{matrix} ) , & ( 11 ) \\ \tilde{R} = ( \begin{matrix}{R}_{11}^{F} & {R}_{12} V \\ 0 & S\end{matrix} ) ≡ ( \begin{matrix}{\tilde{R}}_{11} & {\tilde{R}}_{12} \\ 0 & {\tilde{R}}_{22}\end{matrix} ) , & ( 12 ) \\ b = ( \begin{matrix}{\tilde{Q}}^{T} y \\ 0\end{matrix} ) ≡ [ \begin{matrix}( \begin{matrix}{b}^{F} \\ {b}^{P}\end{matrix} ) \\ 0\end{matrix} ] . & ( 13 )\end{matrix}$$

### Solution Steps (Repeated for Each Regularization/Smoothing Parameter):

(e) For each given a (and/or D^{P}) form:

$${\tilde{D}}_{α} = \sqrt{α} {D}^{P} V and {\tilde{W}}_{α} = ( \begin{matrix}S \\ {\tilde{D}}_{α}\end{matrix} ) .$$

(f) Obtain the QR decomposition \tilde{W}_{α}=Q′R′.

$$( g ) Form c = ( {R}^{′} ) {( {Q}^{′} )}^{T} ( \begin{matrix}{b}^{P} \\ 0\end{matrix} ) . \\ ( h ) Solve {\hat{β}}_{α}^{a} = ( \begin{matrix}{\tilde{R}}_{11}^{- 1} ( {b}^{F} - {\tilde{R}}_{12} c ) \\ Vc\end{matrix} ) .$$

The matrix factorization steps (a)-(d) only need to be carried out once for a given design matrix C. These steps provide the factorization C=\tilde{Q}\tilde{R}\tilde{V} and have a computational cost of O(mn²) flops. The solution steps (e)-(h) present a sequence of candidate smoothing parameters, α and/or D^{P}, and obtain the corresponding least squares solution. In the solution steps, the QR decomposition for \tilde{W}_{α} in step (f), costing up to O(n^{P})³ flops, will dominate the computational load in most P-spline applications. In the special case D^{P}=I, the cost of Steps (e)-(h) can be reduced to O(n^{P}). Recall that in typical P-spline applications n^{P} is much smaller than the number of observations, i.e. rows of C, so the cost of steps (e)-(h) may be small relative to that of steps (a)-(d) regardless of the structure of D^{P}.

In order to better understand the algorithm, note that

$$( \begin{matrix}{SV}^{T} \\ {D}^{P}\end{matrix} ) = ( \begin{matrix}S \\ {D}^{P} V\end{matrix} ) {V}^{T} ≡ ( \begin{matrix}{\tilde{R}}_{22} \\ {D}^{P} V\end{matrix} ) {V}^{T} , \qquad ( 14 )$$

and when solving for the n^{P} penalized terms, the computations can be carried out in a coordinate system where \tilde{R}₂₂ is diagonal and converted back to the standard Cartesian basis in the final step. A meaningful solution of the algorithm may require R₁₁^{F} to be full rank. Ill-conditioning can readily be checked in the unpenalized terms by computing the condition number of R₁₁^{F}. If all terms are penalized, the algorithm will have a meaningful mathematical solution for any α>0 and positive definite (D^{P})^{T}D^{P}.

In numerical implementations, it may be necessary to ensure that when \tilde{D}_{α} is appended to S in step (e), that the condition number is such that numerically meaningful results can be obtained with the machine precision available. Note that the diagonal nature of \tilde{R}₂₂ (i.e. S) allows for control on the lowest singular value associated with the regularized least squares problem when α is small. This can be done by finding the columns corresponding to the smallest computed singular values of S, and then choosing the corresponding columns from D^{P}V. With these columns, a new matrix may be formed, and the corresponding singular values can be computed. For a fixed D^{P}, the SVD only needs to be done once. The value \sqrt{α} can be multiplied by the smallest of these singular values to provide a rough lower bound of the smallest singular value associated with the penalized regression problem. The large case (i.e. heavy smoothing) is not problematic from a matrix inversion standpoint as long as (D^{P})^{T}D^{P} is (numerically) positive definite, which is a condition that may be required by the procedure to have a well-defined solution. Situations where the (D^{P})^{T}D^{P} positive definite assumption is violated can occur when D^{P}V happens to be singular or poorly conditioned. However, even if the positive definite assumption is violated, the algorithm may still be able to return meaningful results. For example, the singular columns of D^{P}V would need to align with the small S columns in order to cause computational problems with matrix inversion in the large a case. Numerical difficulties with matrix inversion encountered using a large a indicate that a penalty matrix is interacting in an unfavorable (likely unintended) fashion with the proposed design matrix. Such difficulties, which are unlikely to occur in practice, may indicate that the positive definite (D^{P})^{T}D^{P} condition required to guarantee meaningful results from the algorithm has been violated. The discussion above was relevant to general square D^{P}'s, but the situation simplifies considerably in the case where D^{P} corresponds to the identity matrix (I). The positive definite condition is met in this special case which is discussed further below.

In some cases, it may be best to let the machine precision available limit the range of a that can be numerically explored, along with the range of the (D^{P})^{T}D^{P} that can be used in computation, in order to solve the problem posed and not to combine penalized regression problems with singular value truncation as is sometimes done. In this way, the original regression problem can be solved. Singular value truncation can remove linear combinations of the design matrix columns, and the “deleted” columns can be hard to physically interpret/understand in the types of regression splines considered here. If identifying poor design matrices is of concern, this situation can be identified by inspecting S=\tilde{R}₂₂. It can be demonstrated that the method can readily handle exactly singular design matrices when a positive definite (D^{P})^{T}D^{P} is used for the smoothing penalty. The algorithm can be used by semi-parametric regression schemes seeking least squares solutions using any valid penalty matrix, but it was designed to achieve efficient DR type computations in the case that D^{P}=I. This choice of D^{P} may be advantageous when a TPF basis in regression splines is used. The F/P partitioning allows for solving the least squares problem using two different QR factorizations. In the D^{P}=I case, the second QR factorization and matrix inversion executed in steps (f)-(g) can be efficiently carried out. To see this, note that these steps aim at finding the vector x that minimizes the following:

$${‖ ( \begin{matrix}S \\ \sqrt{α } V\end{matrix} ) x - ( \begin{matrix}{b}^{p} \\ 0\end{matrix} ) ‖}_{2}^{2} = {‖ ( \begin{matrix}I & 0 \\ 0 & V\end{matrix} ) ( \begin{matrix}S \\ \sqrt{α } I\end{matrix} ) x - ( \begin{matrix}{b}^{p} \\ 0\end{matrix} ) ‖}_{2}^{2} . \qquad ( 15 )$$

Givens rotations known in the art can be used to efficiently provide the QR decomposition needed to find the x yielding the minimum, denoted by c. The solution is given by the expression c=Λ⁻¹Sb^{P} where Λ=S^{T}S+αI is a diagonal matrix. \sqrt{Λ} may be the upper triangular matrix of a QR decomposition available after applying a sequence of Givens rotations to the sparse matrix (S, \sqrt{α}I)^{T}. The result of applying the same sequence of Givens rotations to the vector containing b^{P} in the norm expression above is (\sqrt{Λ})⁻¹Sb^{P}. The Givens rotations are computationally inexpensive and utilize quantities already constructed in steps (a)-(d). Specifically steps (e)-(g) can be performed in O(n^{P}) flops. Step (f) may remain unchanged.

An appealing feature of P-splines is that an n^{P}≦n≦n<<m can be used to accurately represent some complex data sets. Another appealing feature of the QR based approach is that columns/rows of C can readily be modified, added, and/or deleted. In some spline applications, letting the data modify the design matrix is desirable, and the formulation in the invention can account for many such changes in the design matrix using low-rank updates to the various decompositions. A feature that may be particularly important to statistical applications is that for a fixed design matrix one can obtain most quantities of interest to semi-parametric regression, e.g. residual sum of squares, \hat{β}^{α}, various traces and covariance matrices, etc., for several trial a and/or D^{P} by repeating the solution steps and using the matrix decomposition in hand to cheaply compute various quantities.

To better quantitatively illustrate the connection between traditional least squares regularization and the likelihood of a mixed effects models, b can be rescaled to be an isotropic mean zero Gaussian random with unit covariance by absorbing the variance scale into a new random effects matrix Z_{θ}, where θ contains the scale (and possibly other parameters; e.g., the mixed effect approach allows one to readily include “Kriging” parameters). Note that this moves the method into the computational framework where the fast and stable Given rotations based version of the matrix decomposition method are applicable. In some embodiments, the SVD of the factor random effects can be scaled using α and then the analogous problem can be solved as would be understood by one having skill in the art. The scaled random effect can be written as u, assuming that it is drawn from a standard Gaussian with the identity matrix as the covariance. It can be shown that the maximum likelihood solution to the mixed effects model is equivalent to the following optimization problem:

$${r}_{θ , β}^{2} = {min}_{u} {‖ y - X β - {Z}_{θ} u ‖}_{2}^{2} + {‖ u ‖}_{2}^{2} \qquad ( 16 )$$

where the remaining fixed-effect coefficient β and u can be obtained by standard least squares techniques, and the “penalty” one imposes for using large u values may be determined by θ and the (unknown) noise level σ². However, an MLE of the noise, \hat{σ}², can be derived by noting that the maximum a posteriori estimate of u, denoted by ũ for any value of θ, solves:

$$\tilde{u} = arg {min}_{u} {‖ ( \begin{matrix}y - X β \\ 0\end{matrix} ) - ( \begin{matrix}{Z}_{θ} \\ I\end{matrix} ) u ‖}_{2}^{2} \qquad ( 17 )$$

where I is a q dimensional square identity matrix. Z can be assumed to have q columns where q is less than or equal to the number of y observations where there are n sets of scatterplot observations in total. The solution to the above can readily obtained by least squares by solving the matrix equation (Z_{θ}^{T}Z_{θ}+I)ũ=Z_{θ}^{T}(y−Xβ). This equation can be solved using Cholesky factors, L_{θ}L_{θ}^{T}:=Z_{θ}^{T}Z_{θ}+I. Alternatively, QR methods may also be used to solve this problem if Cholesky factorization is inefficient or unstable. This decomposition can be used to rewrite the least squares problem cost function for general u as:

$${min}_{u} {‖ y - X β - {Z}_{θ} u ‖}_{2}^{2} + {‖ u ‖}_{2}^{2} = {r}_{θ , β}^{2} + {‖ {L}_{θ}^{T} ( u - \tilde{u} ) ‖}_{2}^{2} . \qquad ( 18 )$$

Writing the above RHS is advantageous because one can “integrate out” u and express the likelihood function L(θ, β, σ) in terms of quantities defined above. Note that the lines below show explicitly how equation (8) above is derived).

$$\begin{matrix}ℒ ( θ , β , σ ) = {\int }_{{ℝ}^{q}}^{ } \frac{1}{{( 2 {πσ}^{2} )}^{n + q ) / 2}} exp ( - \frac{{r}_{θ , β}^{2} + {‖ {L}_{θ}^{T} ( u - \tilde{u} ) ‖}_{2}^{2}}{2 {σ}^{2}} ) d u & ( 19 ) \\ = \frac{exp ( - \frac{{r}_{θ , β}^{2}}{2 {σ}^{2}} )}{{( 2 {πσ}^{2} )}^{n / 2}} {\int }_{{ℝ}^{q}}^{ } \frac{1}{{( 2 π )}^{q / 2}} exp ( \frac{- {‖ {L}_{θ}^{T} ( u - \tilde{u} ) ‖}_{2}^{2}}{2 {σ}^{2}} ) \frac{\vert {L}_{θ} \vert}{\vert {L}_{θ} \vert} \frac{d u}{{σ}^{q}} & ( 20 ) \\ = \frac{exp ( - \frac{{r}_{θ , β}^{2}}{2 {σ}^{2}} )}{{( 2 {πσ}^{2} )}^{n / 2} \vert {L}_{θ} \vert} {\int }_{{ℝ}^{q}}^{ } \frac{1}{{( 2 π )}^{q / 2}} exp ( - {‖ z ‖}_{2}^{2} ) \frac{d z}{1} & ( 21 ) \\ = \frac{exp ( - \frac{{r}_{θ , β}^{2}}{2 {σ}^{2}} )}{{( 2 {πσ}^{2} )}^{n / 2} \vert {L}_{θ} \vert} & ( 22 )\end{matrix}$$

where a linear transformation (z) and a change of variables are exploited to obtain the likelihood. The deviance, defined as −2 times the log likelihood, then becomes:

$$- 2 log ( L ( θ , β , σ ) ) = n log ( 2 {πσ}^{2} ) + 2 log \vert {L}_{θ} \vert + \frac{{r}_{θ , β}^{2}}{{σ}^{2}} \qquad ( 23 )$$

The MLE σ²=r_{θ,β}²/n is for all values of β and θ. The MLE \hat{β} involves a standard least squares regression in the Gaussian linear mixed effects model considered, so only the parameter θ that maximizes the deviance needs to be found. (The MLEs can be plugged in to eliminate the other variables). If θ only scales the random effect, then the σ_{b}²σ2b implied by the observations can be estimated by \hat{σ}_{b}²:=\hat{θ}²\hat{σ}².

The factorization allows for a vectorized likelihood function evaluation in the case where θ is a scalar. This vectorized evaluation may also be relevant to the general Z_{θ} if the optimization routine scans one coordinate of θ at a time. In this case, |L_{θ}| can be efficiently computed by carrying out a single SVD decomposition of Z where Z_{θ}:=θZ in the special case under consideration. The resulting singular values may be denoted by the vector s^{(z)} with components sᵢ^{(z)}. For each candidate θ,

$$log \vert {L}_{θ} \vert = \frac{1}{2} \sum log ( {( {s}_{i}^{( z )} θ )}^{2} + 1 )$$

can be efficiently computed in a vectorized fashion. This process coupled with the other highly vectorized solves (discussed below) makes computing the MLE computationally efficient without sacrificing numerical stability. Furthermore, the case where D^{P} is an arbitrary, positive, semi-definite, diagonal matrix can be solved efficiently using minor modifications to the method described above. Specifically, carrying out the first expensive QR step may not be needed. These details would be clearly understood by one who is proficient in the art.

Additionally, the following commonly used quantities in regression computations can be readily computable from the algorithm where D^{P}=I is assumed. These quantities below can be computed for multiple α values without repeating the matrix factorization steps (a)-(d). For example, the residual degrees of freedom can be computed as:

dfᵣₑₛ(α)=m−2df_{fit}(α)+(n−n^{P})+Σᵢ₌₁ⁿ^{^{P}}(Sᵢᵢ²/(Sᵢᵢ²+α))² (24)

along with other values, such as:

df_{fit}(α)=n−n^{P}+Σᵢ₌₁ⁿ^{^{P}}Sᵢᵢ²/(Sᵢᵢ²+α) (25)

RSS(α)=∥y−C\hat{β}^{α}∥₂²=∥y∥₂²−∥(b_{F},Sc,\sqrt{2α}c)^{T}∥₂² (26)

GCV(α)=RSS(α)/(1−df_{fit}(α)/m)² (27)

AIC_{c}(α)=log [RSS(α)]+2(df_{fit(α)}+1)/(m−df_{fit}(α)−2) (28)

The residual sum of squares comes from the definition of \hat{β}_{α}^{a}(\hat{β}_{α}^{T}, û_{α}^{T})^{T}, i.e.

$$( \begin{matrix}C \\ \sqrt{α} D\end{matrix} ) ⊥ ( ( \begin{matrix}y \\ 0\end{matrix} ) - ( \begin{matrix}C \\ \sqrt{α} D\end{matrix} ) {\hat{β}}_{α}^{a} ) . \qquad ( 29 )$$

The trace computations are easy to accomplish because a DR-type decomposition on Z^{P} can be used. The free columns (X^{F} and Z^{F}) contribute n−n^{P} to the trace because these matrices are unaffected by D. Pointwise confidence bands on design points xᵢ associated with a given α and C can be obtained by computing a vectorized solve for the smoother matrix using the identity matrix in place of the data vector y.

### Applying the LME Algorithm to General Longitudinal Data Analysis

Design matrices can be constructed using repeated blocks of one form. The resulting matrix may then be used in a longitudinal data type modeling situation. In some of the models considered, the algorithm can be used to substantially reduce the work load. Because only nₚ terms need to be penalized, the efficiency can be increased. In some design matrices, this may represent a small fraction of the overall design matrix and hence substantial savings may occur in steps (e)-(h) of the algorithm described above. In some of the discussion below, the known Demmler-Reinsch numerical approximation/regularization may be used. The Demmler-Reinsch algorithm may be labeled as the “DR algorithm.” Additionally, some possible dangers of making unnecessary numerical approximations may be highlighted.

In one example of the data generation process, data may be generated according to:

yᵢⱼ(xᵢ)=g(xᵢ)+hⱼ(xᵢ,θⱼ)+εᵢⱼ, (30)

where εᵢⱼ are Normal (0, 1) and independent, xᵢ are equally spaced on [0, 15], and j=1, . . . , G. The term hⱼ(xᵢ, θⱼ) may be given by θⱼ⁽¹⁾(ωⱼ)+θⱼ⁽²⁾(ωⱼ)a tan((xᵢ−μ)/γ)+θⱼ⁽³⁾(ωⱼ)(xᵢ−φ)₊² with θⱼⁱ(ωⱼ) denoting that component i of θⱼ and ωⱼ is used to indicate that θⱼ is a random vector corresponding to sample j. The parameters of hⱼ(x) may include μ=7.5, γ=6, and φ=9. The nonlinear function g(x) used in this simulation may be defined by:

$$g ( x ) = - ( 2.5 sin ( 2 π \frac{6 x}{15} ) + 9 exp ( - \frac{{( x - 3 )}^{2}}{2} ) + 5 exp ( - \frac{{( x - 10 )}^{2}}{2} ) - 2 ) / 3. , \qquad ( 31 )$$

A mixture of normals may be used for the random intercept term θ⁽¹⁾). Specifically a uniform random variable, pⱼ^{u} on [0, 1] may be drawn, and if pᵤ<0.75 then θⱼ⁽¹⁾˜N(0.5, 0.25) otherwise θⱼ⁽¹⁾˜N(1.5, 0.25). The other θ⁽ⁱ⁾'s may be distributed using independent Normal (0, 1) variables. In a particular example, one “curve batch” may include G=25 (or 5 curves), with each function sampled at m=40 values of xᵢ. A total of 5000 such curve batches were analyzed in a Monte Carlo study. The particular sampling grid was identical for each curve. In some cases considered, in addition to it was also assumed that an estimate of σyᵢ_{^{j}}=∂fⱼxᵢ+εᵢⱼ′ was available, where ∂f(xᵢ)≡df(x)/d(x)|x=xᵢ and εᵢⱼ′ denoted Normal (0, 1) independent and identically distributed random variables that were also independent of the εᵢⱼ. The simultaneous use of derivative and function estimates facilitated in tuning the condition number of the design matrix. Advantageously, the algorithm was developed to treat ill-conditioned design matrices that can result in this type of situation where other algorithms would typically fail.

Semi-parametric models may be of particular interest. Generally, semi-parametric regression models can be ignorant of the parametric form of h(•; θ), however it may also be useful to study situations where this structure is assumed to be known. The interest is in both estimating the hⱼ's and g. For example, departures from the mean function, quantified through the hⱼ's, have been observed to have physical significance in some situations. In applications like proteomics or spectroscopic curve analysis, the interest is usually in the population function g(x), and the hⱼ's are considered nuisance functions resulting from hard-to-avoid experimental drift and/or systematic baseline correction errors. To model these curves, several different design matrices may be used, each of which may have the following structure:

$$yB = ( \begin{matrix}X \\ ⋮ \\ X\end{matrix} ) β + ( \begin{matrix}{Z}^{{F}_{1}} & & 0 \\ & ⋱ & \\ 0 & & {Z}^{{F}_{G}}\end{matrix} ) {u}_{B}^{F} + ( \begin{matrix}{Z}^{{P}_{1}} & & 0 \\ & ⋱ & \\ 0 & & {Z}^{{P}_{G}}\end{matrix} ) {u}_{B}^{P} + ( \begin{matrix}{Z}^{P} \\ ⋮ \\ {Z}^{P}\end{matrix} ) {u}^{P} , \qquad ( 32 )$$

where the subscript B on the vectors is used to remind the reader that G copies of discrete function samples are stacked, each containing either m observations, or 2m observations if derivative information is used. Another way of characterizing this setup is use identical design matrices corresponding to h_{g}(x) and hₖ(x), but which for i≠k correspond to different P-spline coefficients.

In the design matrices, what is known as the Generalized Additive Models (GAM) refers to the case where it may be assumed that the functional form of the basis functions used to generate the data are known, hence only the θ⁽ⁱ⁾'s for each curve sample j need to be estimated. In the GAM case, the fixed effects can be modified to X=x₁, x₁²; . . . ; xₘ, xₘ². The Z^{F}^{ᵢ} may each have 4 columns: one for the random intercept and the other three for the shape functions, which in this case may correspond to Z^{P}^{ᵢ}=0.

Recall that the design matrices were characterized by 2 P-splines. In contrast to the GAM case, it can now be assumed that the functional form of the basis functions describing the hⱼ is unknown. This particular design matrix may attempts to find a regression spline for both g and hⱼ. The Z^{F}^{ᵢ} in this case may include the linear polynomial terms for the G curves, and the fixed effects matrix may include the quadratic polynomial term. The Z^{P}^{ᵢ} may correspond to another knot sequence and TPF basis using K′ knots that are uniformly spaced.

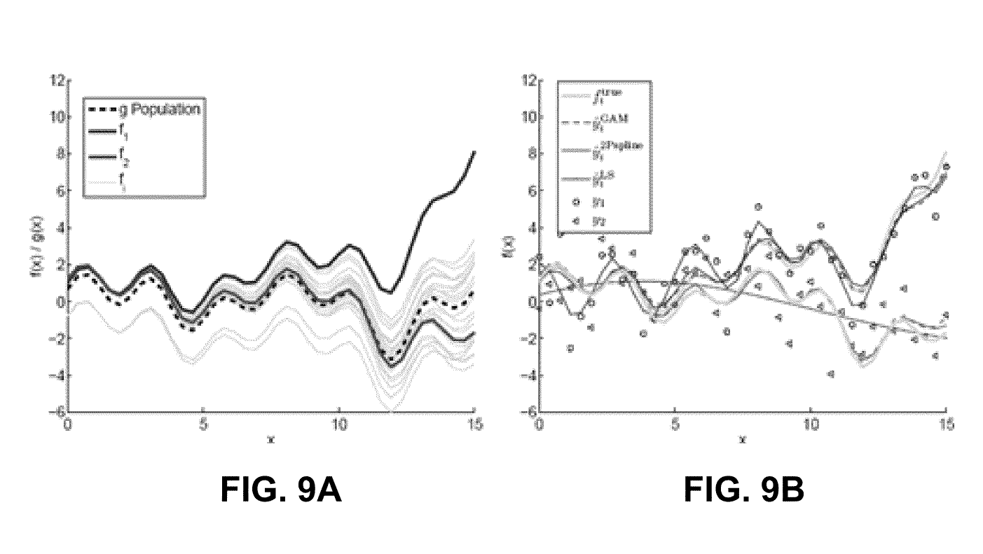

FIG. 9A illustrates a sample of an observed curve population. The curves labeled fᵢ may be considered generic samples, while those labeled f₁ and f₂ be may considered to be estimated from noisy samples depicted in FIG. 9B, where the symbols denote the observed yᵢ and the curves denote the various estimates of the curves highlighted in FIG. 9A. The remaining curve shows the known “truth,” and “LS” represents a standard least squares regression fit. In these figures, G=25 curves are depicted, along with three different estimates of these curves. In this embodiment, the naive least squares estimate may simply fit a P-spline to each of the curves. Here AMSE may be computed for both the prediction of the individual curves, as well as the estimate of the common population function g. As shown, the GAM method using derivative information outperforms all other methods. When such functions are known, a substantial amount of dimensional reduction can be achieved because only one large scale QR factorization is needed before the factorizations associated with the relatively small R₂₂^{P} matrix to evaluate different proposed smoothing parameters can be computed. Note that for large scale applications, this expensive QR factorization readily lends itself to parallelization.

In some of the largest cases studied, the design matrix used by the 2 P-spline model used derivative and function information, each curve consisted of 40 functions and 40 derivative scatter-plot samples, the parameters comprised G=25, K=60, and K′=15, along with the penalized and free polynomial terms resulting in C∈ [symbol] ^{2000x486}. The GCV was evaluated over a grid of 1000 points logarithmically spaced between 1×10⁻¹⁴ and 1×10¹⁴, and the corresponding \hat{α}, [symbol] , and \hat{z} were computed in less than 2.20 seconds. All of these computations were carried out on a PC running MATLAB in Windows XP using an Intel Pentium D 3 GHz CPU using 3.5 GB RAM. This timing result is likely unrepresentative of P-spline fits aiming at estimating a single curve, because the number of columns was likely larger than would normally be needed in typical tasks of this sort. For comparison, the same operations as before were carried, but with p=2 using the “typical” TPF basis and with 5000×2 observations of the function and derivative. This second set of operations took 8.74×10⁻² seconds to compute when K=50, and 3.95×10⁻¹ seconds for K=100.

Ignorance of the functional form of the shape function is common in actual data. Therefore, it is reassuring that the 2 P-Spline approach can work even in situations where the number of columns in the design matrix can grow very rapidly. Considering that the condition number of the spline matrix Z can grow rapidly in this situation regardless of the basis, this could otherwise present serious computational problems. The P-spline framework has a natural regularization parameter built into the regression. The probable ill-conditioning of Z often forces many researchers to introduce arbitrary parameters to provide numerical answers, and thus requiring another regularization. For example, the commonly used the DR algorithm is particularly susceptible to this problem, and in some cases may require a Cholesky factor of C^{T}C. Since the condition number of C is large, this can be problematic in even small scale problems. To remedy this situation, the many DR implementations obtain a Cholesky factor of C^{T}C+ηD instead. This regularized solution may then be used to select an α that further smooths and can be used to estimate f. Other known solutions suggest that using a pivoted QR in conjunction with a truncated SVD instead; however, the cut-off criterion is arbitrary, and using a poor criterion may obscure results. The embodiments described herein solve these and other problems.

The design matrices defined above may require the specification of X, Z^{P}, Z^{P}^{ᵢ} and Z^{F}^{ᵢ}. Recall the later two spline design matrices can be identical for each subject. Also recall h^{(j)}(xᵢ)θⱼ⁽¹⁾(ω)+θ₁⁽²⁾(ω)a tan ((xᵢ−μ/γ)+θⱼ⁽³⁾(ω)(xᵢ−φ)₊² with values of ∥=7.5, γ=6, and φ=9. Also note that ψ¹(x)=1, ψ²(X)=a tan((x−μ)/γ), and ψ³(x)=(xᵢ−φ)₊². The ∂ symbol appearing below represents differentiation with respect to x, e.g. ∂x²=2x.

Case 1: “(GAM, f)”:

$$X = ( \begin{matrix}{x}_{1} , {x}_{1}^{2} \\ ⋮ \\ {x}_{m} , {x}_{m}^{2}\end{matrix} ) , \\ {Z}^{P} = ( \begin{matrix}{( {κ}_{1} - {x}_{1} )}_{+}^{2} … {( {κ}_{K} - {x}_{i} )}_{+}^{2} \\ ⋮ \\ {{κ}_{1} - {x}_{m} )}_{+}^{p} … {( {κ}_{K} - {x}_{m} )}_{+}^{2}\end{matrix} ) , \\ {Z}^{{F}_{i}} = ( \begin{matrix}{ψ}^{1} ( {x}_{1} ) , {ψ}^{2} ( {x}_{1} ) , {ψ}^{3} ( {x}_{1} ) \\ ⋮ \\ {ψ}^{1} ( {x}_{m} ) , {ψ}^{2} ( {x}_{m} ) , {ψ}^{3} ( {x}_{m} )\end{matrix} ) , \\ {Z}^{{P}_{i}} = 0$$

Case 2 “GAM, f, ∂f”:

$$X = ( \begin{matrix}\begin{matrix}{x}_{1} , {x}_{1}^{2} \\ ⋮ \\ {x}_{m} , {x}_{m}^{2}\end{matrix} \\ 1 , 2 {x}_{1} \\ ⋮ \\ 1 , 2 {x}_{m}\end{matrix} ) , \\ {Z}^{P} = ( \begin{matrix}\begin{matrix}{( {κ}_{1} - {x}_{1} )}_{+}^{2} … {( {κ}_{K} - {x}_{1} )}_{+}^{2} \\ ⋮ \\ {( {κ}_{1} - {x}_{m} )}_{+ }^{2} … {( {κ}_{K} - {x}_{m} )}_{+}^{2}\end{matrix} \\ 2 {( {κ}_{1} - {x}_{1} )}_{+ } … 2 {( {κ}_{K} - {x}_{1} )}_{+}^{2} \\ ⋮ \\ 2 {( {κ}_{1} - {x}_{m} )}_{+} … 2 {( {κ}_{K} - {x}_{m} )}_{+}^{2}\end{matrix} )$$

$${Z}^{{F}_{i}} = ( \begin{matrix}\begin{matrix}{ψ}^{1} ( {x}_{1} ) , {ψ}^{2} ( {x}_{1} ) , {ψ}^{3} ( {x}_{1} ) \\ ⋮ \\ {ψ}^{1} ( {x}_{m} ) , {ψ}^{2} ( {x}_{m} ) , {ψ}^{3} ( {x}_{m} )\end{matrix} \\ \partial {ψ}^{1} ( {x}_{1} ) , \partial {ψ}^{2} ( {x}_{1} ) , \partial {ψ}^{3} ( {x}_{1} ) \\ ⋮ \\ \partial {ψ}^{1} ( {x}_{m} ) , \partial {ψ}^{2} ( {x}_{m} ) , \partial {ψ}^{3} ( {x}_{m} )\end{matrix} )$$

$${Z}^{{P}_{i}} = 0.$$

Case 3“2 P-Spline, f”:

$$X = ( \begin{matrix}{x}_{1}^{2} \\ ⋮ \\ {x}_{m}^{2}\end{matrix} ) , {Z}^{P} = ( \begin{matrix}{( {κ}_{1} - {x}_{1} )}_{+}^{2} … {( {κ}_{K} - {x}_{1} )}_{+}^{2} \\ ⋮ \\ {( {κ}_{1} - {x}_{m} )}_{+}^{2} … {( {κ}_{K} - {x}_{m} )}_{+}^{2}\end{matrix} ) , \\ {Z}^{{F}_{i}} = ( \begin{matrix}1 , {x}_{1} \\ ⋮ \\ 1 , {x}_{m}\end{matrix} ) , {Z}^{{P}_{i}} = ( \begin{matrix}{( {κ}_{1}^{′} - {x}_{1} )}_{+} … {( {κ}_{{K}^{′}}^{′} - {x}_{1} )}_{+} \\ ⋮ \\ {( {κ}_{1}^{′} - {x}_{m} )}_{+} … {( {κ}_{{K}^{′}}^{′} - {x}_{m} )}_{+}\end{matrix} )$$

Case 4“2 P-Spline, f, ∂f”:

$$X = ( \begin{matrix}\begin{matrix}{x}_{1}^{2} \\ ⋮ \\ {x}_{m}^{2}\end{matrix} \\ 2 {x}_{1} \\ ⋮ \\ 2 {x}_{m}\end{matrix} ) , {Z}^{P} = ( \begin{matrix}\begin{matrix}{( {κ}_{1} - {x}_{1} )}_{+}^{2} … {( {κ}_{K} - {x}_{1} )}_{+}^{2} \\ ⋮ \\ {( {κ}_{1} - {x}_{m} )}_{+}^{2} … {( {κ}_{K} - {x}_{m} )}_{+}^{2}\end{matrix} \\ 2 {( {κ}_{1} - {x}_{1} )}_{+} … 2 {( {κ}_{K} - {x}_{1} )}_{+}^{2} \\ ⋮ \\ 2 {( {κ}_{1} - {x}_{m} )}_{+} … 2 {( {κ}_{K} - {x}_{m} )}_{+}^{2}\end{matrix} ) , \\ {Z}^{{F}_{i}} = ( \begin{matrix}\begin{matrix}1 , {x}_{1} \\ ⋮ \\ 1 , {x}_{m}\end{matrix} \\ 0 , 1 \\ ⋮ \\ 0 , 1\end{matrix} ) , {Z}^{{P}_{i}} = ( \begin{matrix}\begin{matrix}{( {κ}_{1}^{′} - {x}_{1} )}_{+} … {( {κ}_{{K}^{′}}^{′} - {x}_{1} )}_{+} \\ ⋮ \\ {( {κ}_{1}^{′} - {x}_{m} )}_{+} … {( {κ}_{{K}^{′}}^{′} - {x}_{m} )}_{+}\end{matrix} \\ {1}_{( {κ}_{1}^{′} - x ) > 0} ( {x}_{1} ) … {1}_{( {κ}_{{K}^{1}}^{′} - x ) > 0} ( {x}_{1} ) \\ ⋮ \\ {1}_{( {κ}_{1}^{′} - x ) > 0} ( {x}_{m} ) … {1}_{( {κ}_{{K}^{1}}^{′} - x ) > 0} ( {x}_{m} )\end{matrix} ) ,$$

Note that {κ₁′}₁^{κ′} may be a uniformly spaced knot sequence distinct from {κ₁}₁^{κ} using κ₁′=κ₁+10π/K and κ_{K′}′=κ_{K}−10π/K with K′<K and 1_{(κ}_{₁}_{′-x)>0}(.) as the indicator function taking a value of 1 if (κ₁′−x)>0 and 0 otherwise. Note that similar results may be obtained using design matrices with Z^{P}^{ᵢ} corresponding to quadratic terms.

### Hardware

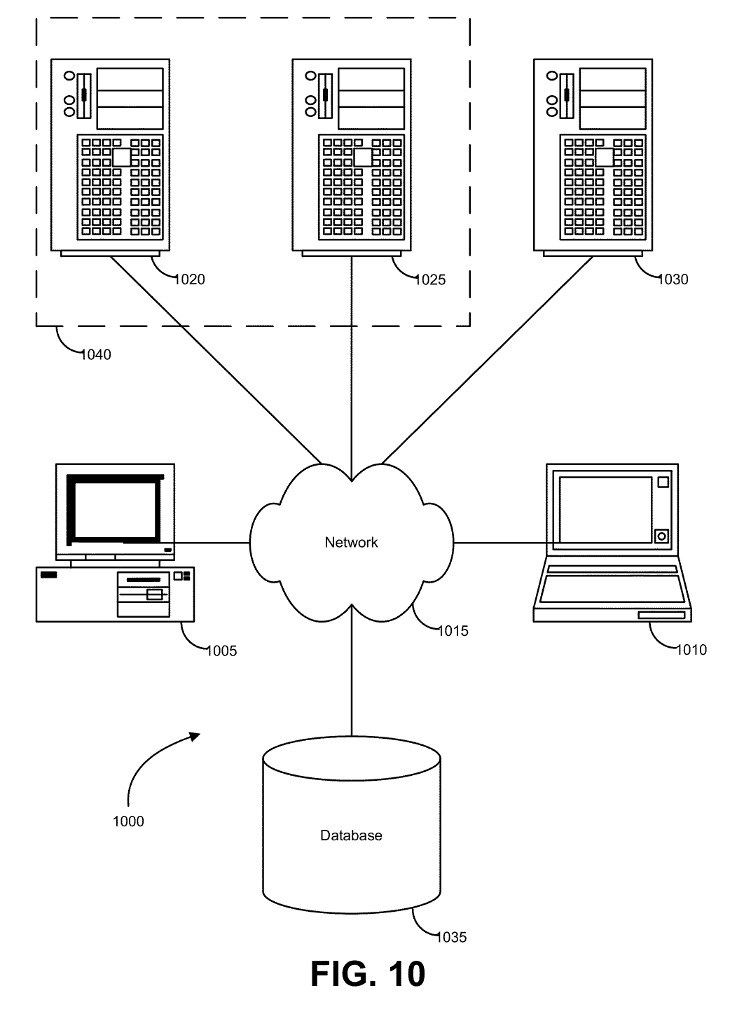

Each of the embodiments disclosed herein may be implemented in a computer system. FIG. 10 is a block diagram illustrating components of an exemplary operating environment in which various embodiments of the present invention may be implemented. The system 1000 can include one or more user computers 1005, 1010, which may be used to operate a client, whether a dedicated application, web browser, etc. The user computers 1005, 1010 can be general purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, the variety of GNU/Linux operating systems). These user computers 1005, 1010 may also have any of a variety of applications, including one or more development systems, database client and/or server applications, and web browser applications. Alternatively, the user computers 1005, 1010 may be any other electronic device, such as a thin-client computer, Internet-enabled mobile telephone, and/or personal digital assistant, capable of communicating via a network (e.g., the network 1015 described below) and/or displaying and navigating web pages or other types of electronic documents. Although the exemplary system 1000 is shown with two user computers, any number of user computers may be supported.

In some embodiments, the system 1000 may also include a network 1015. The network may can be any type of network familiar to those skilled in the art that can support data communications using any of a variety of commercially-available protocols, including without limitation TCP/IP, SNA, IPX, AppleTalk, and the like. Merely by way of example, the network 1015 may be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO etc.

The system may also include one or more server computers 1020, 1025, 1030 which can be general purpose computers and/or specialized server computers (including, merely by way of example, PC servers, UNIX servers, mid-range servers, mainframe computers rack-mounted servers, etc.). One or more of the servers (e.g., 1030) may be dedicated to running applications, such as a business application, a web server, application server, etc. Such servers may be used to process requests from user computers 1005, 1010. The applications can also include any number of applications for controlling access to resources of the servers 1020, 1025, 1030.

The web server can be running an operating system including any of those discussed above, as well as any commercially-available server operating systems. The web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 1005, 1010. As one example, a server may execute one or more web applications. The web application may be implemented as one or more scripts or programs written in any programming language, such as Java™, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 1005, 1010.

In some embodiments, an application server may create web pages dynamically for displaying on an end-user (client) system. The web pages created by the web application server may be forwarded to a user computer 1005 via a web server. Similarly, the web server can receive web page requests and/or input data from a user computer and can forward the web page requests and/or input data to an application and/or a database server. Those skilled in the art will recognize that the functions described with respect to various types of servers may be performed by a single server and/or a plurality of specialized servers, depending on implementation-specific needs and parameters.

The system 1000 may also include one or more databases 1035. The database(s) 1035 may reside in a variety of locations. By way of example, a database 1035 may reside on a storage medium local to (and/or resident in) one or more of the computers 1005, 1010, 1015, 1025, 1030. Alternatively, it may be remote from any or all of the computers 1005, 1010, 1015, 1025, 1030, and/or in communication (e.g., via the network 1020) with one or more of these. In a particular set of embodiments, the database 1035 may reside in a storage-area network (“SAN”) familiar to those skilled in the art. Similarly, any necessary files for performing the functions attributed to the computers 1005, 1010, 1015, 1025, 1030 may be stored locally on the respective computer and/or remotely, as appropriate. In one set of embodiments, the database 1035 may be a relational database, such as Oracle 10g, that is adapted to store, update, and retrieve data in response to SQL-formatted commands.

FIG. 11 illustrates an exemplary computer system 1100, in which various embodiments of the present invention may be implemented. The system 1100 may be used to implement any of the computer systems described above. The computer system 1100 is shown comprising hardware elements that may be electrically coupled via a bus 1155. The hardware elements may include one or more central processing units (CPUs) 1105, one or more input devices 1110 (e.g., a mouse, a keyboard, etc.), and one or more output devices 1115 (e.g., a display device, a printer, etc.). The computer system 1100 may also include one or more storage device 1120. By way of example, storage device(s) 1120 may be disk drives, optical storage devices, solid-state storage device such as a random access memory (“RAM”) and/or a read-only memory (“ROM”), which can be programmable, flash-updateable and/or the like.

The computer system 1100 may additionally include a computer-readable storage media reader 1125a, a communications system 1130 (e.g., a modem, a network card (wireless or wired), an infra-red communication device, etc.), and working memory 1140, which may include RAM and ROM devices as described above. In some embodiments, the computer system 1100 may also include a processing acceleration unit 1135, which can include a DSP, a special-purpose processor and/or the like.

The computer-readable storage media reader 1125a can further be connected to a computer-readable storage medium 1125b, together (and, optionally, in combination with storage device(s) 1120) comprehensively representing remote, local, fixed, and/or removable storage devices plus storage media for temporarily and/or more permanently containing computer-readable information. The communications system 1130 may permit data to be exchanged with the network 1120 and/or any other computer described above with respect to the system 1100.

The computer system 1100 may also comprise software elements, shown as being currently located within a working memory 1140, including an operating system 1145 and/or other code 1150, such as an application program (which may be a client application, web browser, mid-tier application, RDBMS, etc.). It should be appreciated that alternate embodiments of a computer system 1100 may have numerous variations from that described above. For example, customized hardware might also be used and/or particular elements might be implemented in hardware, software (including portable software, such as applets), or both. Further, connection to other computing devices such as network input/output devices may be employed. Software of computer system 1100 may include code 1150 for implementing embodiments of the present invention as described herein.

Each step of the methods disclosed herein may be done automatically by the computer system, and/or may be provided as inputs and/or outputs to a user. For example, a user may provide inputs for each step in a method, and each of these inputs may be in response to a specific output requesting such an input, wherein the output is generated by the computer system. Each input may be received in response to a corresponding requesting output. Furthermore, inputs may be received from a user, from another computer system as a data stream, retrieved from a memory location, retrieved over a network, requested from a Web service, and/or the like. Likewise, outputs may be provided to a user, to another computer system as a data stream, saved in a memory location, sent over a network, provided to a web service, and/or the like. In short, each step of the methods described herein may be performed by a computer system, and may involve any number of inputs, outputs, and/or requests to and from the computer system which may or may not involve a user. Therefore, it will be understood in light of this disclosure, that each step and each method described herein may be altered to include an input and output to and from a user, or may be done automatically by a computer system.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

What is claimed is:

1. A method of tracking a plurality of tagged molecules in a cell in two or three dimensions, the method comprising:
receiving, using a computer system, a plurality of unambiguous track segments, wherein each of the plurality of unambiguous track segments comprises a plurality of time-valued observations of individual tagged molecules;
separating the plurality of unambiguous track segments into a plurality of time windows;
for each of the plurality of unambiguous track segments, deriving one or more data sets representing features of the unambiguous track segment; and
associating a first unambiguous track segment from a first time window with a second unambiguous track segment from a second time window using the one or more data sets.

2. The method of claim 1 wherein the one or more data sets comprise a data set representing a velocity of an associated tagged molecule as a function of time or spatial location.

3. The method of claim 1 wherein the one or more data sets comprise a data set representing a matrix of effective force vectors acting on an associated tagged molecule as a function of time or spatial location.

4. The method of claim 1 wherein the one or more data sets comprise a data set representing a diffusion coefficient for an associated tagged molecule as a function of time or spatial location.

5. The method of claim 1 wherein the one or more data sets comprise a data set representing an effective measurement noise magnitude for an associated tagged molecule as a function of time or spatial location.

6. The method of claim 1 wherein associating the first unambiguous track segment from the first time window with the second unambiguous track segment from the second time window using the features comprises:
formulating an association problem using the one or more data sets representing features; and
solving the association problem.

7. The method of claim 1 wherein associating the first unambiguous track segment from the first time window with the second unambiguous track segment from the second time window using the one or more data sets comprises:
creating a semi-parametric model using a Linear Mixed Effect (LME) formulation and the plurality of unambiguous track segments;
computing a Maximum Likelihood Estimate (MLE) for the LME; and
efficiently computing a set of Expected Best Linear Unbiased Parameters (EBLUPs) for each of the unambiguous track segments.

8. The method of claim 7 wherein the first unambiguous track segment from the first time window is associated with the second unambiguous track segment from the second time window using the EBLUPs.

9. The method of claim 8 wherein each of the EBLUPs is associated with kinetic parameters that describes an interaction between the molecule and the environment inside the cell.

10. The method of claim 1 further comprising combining the first unambiguous track segment with the second unambiguous track segment to form a single track segment representing a path of an associated tagged molecule.

11. The method of claim 1 wherein each of the plurality of tagged molecules is tagged such that the molecule, over time, emits a gradually changing fluorescent signature.

12. A computer-readable memory comprising a sequence of instructions which, when executed by one or more processors, causes the one or more processors to track a plurality of tagged molecules in a cell in two or three dimensions by:
receiving a plurality of unambiguous track segments, wherein each of the plurality of unambiguous track segments comprises a plurality of time-valued observations of individual tagged molecules;
separating the plurality of unambiguous track segments into a plurality of time windows;
for each of the plurality of unambiguous track segments, deriving one or more data sets representing features of the unambiguous track segment; and
associating a first unambiguous track segment from a first time window with a second unambiguous track segment from a second time window using the one or more data sets.

13. The computer-readable memory according to claim 12 wherein associating the first unambiguous track segment from the first time window with the second unambiguous track segment from the second time window using the features comprises:
formulating an association problem using the one or more data sets representing features; and
solving the association problem.

14. The computer-readable memory according to claim 12 wherein associating the first unambiguous track segment from the first time window with the second unambiguous track segment from the second time window using the one or more data sets comprises:
creating a semi-parametric model using a Linear Mixed Effect (LME) formulation and the plurality of unambiguous track segments;
computing a Maximum Likelihood Estimate (MLE) for the LME; and
efficiently computing a set of Expected Best Linear Unbiased Parameters (EBLUPs) for each of the unambiguous track segments.

15. The computer-readable memory according to claim 14 wherein the first unambiguous track segment from the first time window is associated with the second unambiguous track segment from the second time window using the EBLUPs.

16. The computer-readable memory according to claim 15 wherein each of the EBLUPs is associated with kinetic parameters that describes an interaction between the molecule and the environment inside the cell.

17. A system comprising:
one or more processors; and
a memory communicatively coupled with and readable by the one or more processors and comprising a sequence of instructions which, when executed by the one or more processors, cause the one or more processors to track a plurality of tagged molecules in a cell in two or three dimensions by:
receiving a plurality of unambiguous track segments, wherein each of the plurality of unambiguous track segments comprises a plurality of time-valued observations of individual tagged molecules;
separating the plurality of unambiguous track segments into a plurality of time windows;
for each of the plurality of unambiguous track segments, deriving one or more data sets representing features of the unambiguous track segment; and
associating a first unambiguous track segment from a first time window with a second unambiguous track segment from a second time window using the one or more data sets.

18. The system of claim 17 wherein the instructions further cause the one or more processors to track the plurality of tagged molecules in the cell in two or three dimensions by combining the first unambiguous track segment with the second unambiguous track segment to form a single track segment representing a path of an associated tagged molecule.

19. The system of claim 17 wherein associating the first unambiguous track segment from the first time window with the second unambiguous track segment from the second time window using the one or more data sets comprises:
creating a semi-parametric model using a Linear Mixed Effect (LME) formulation and the plurality of unambiguous track segments;
computing a Maximum Likelihood Estimate (MLE) for the LME; and
efficiently computing a set of Expected Best Linear Unbiased Parameters (EBLUPs) for each of the unambiguous track segments.

20. The system of claim 17 wherein one or more data sets comprise a data set representing a matrix of effective force vectors acting on an associated tagged molecule as a function of time or spatial location.
